(19) United States
(12) Patent Application Publication
(10) Pub. No.: US 2026/0075453 A1
(43) Pub. Date: Mar. 12, 2026

(54) APPARATUS AND METHOD FOR SUPPORTING LIFE CYCLE MANAGEMENT (LCM) OF MACHINE LEARNING MODEL (ML MODEL)

(71) Applicant: FRAUNHOFER-GESELLSCHAFT ZUR FOERDERUNG DER ANGEWANDTEN FORSCHUNG E.V., Muenchen (DE)

(72) Inventors: Mohammad ALAWIEH, Erlangen (DE); Georgios KONTES, Erlangen (DE); Birendra GHIMIRE, Erlangen (DE)

(21) Appl. No.: 19/388,579

(22) Filed: Nov. 13, 2025

Related U.S. Application Data
(63) Continuation of application No. PCT/EP2024/063233, filed on May 14, 2024.

(30) Foreign Application Priority Data
May 14, 2023 (EP) 23173269.4

(51) Int. Cl. H04W 24/10; H04W 4/029

(52) U.S. Cl. CPC H04W 24/10; H04W 4/029

(57) ABSTRACT

A user equipment of a wireless communication system according to an embodiment is provided.

### CROSS-REFERENCE TO RELATED APPLICATIONS

This application is a continuation of copending International Application No. PCT/EP2024/063233, filed May 14, 2024, which is incorporated herein by reference in its entirety, and additionally claims priority from European Application No. EP 23173269.4, filed May 14, 2023, which is also incorporated herein by reference in its entirety.

The present invention relates to the field of wireless communication systems or networks, in particular to an apparatus and a method for supporting life cycle management (LCM) of machine learning model (ML model). In general, embodiments are in the field of AI/ML solutions in context of NR-/3GPP-networks.

### BACKGROUND OF THE INVENTION

FIG. 11 is a schematic representation of an example of a terrestrial wireless network 100 including, as is shown in FIG. 11(a), the core network and one or more radio access networks RAN₁, RAN₂, . . . RAN_{N} (RAN=Radio Access Network). FIG. 11(b) is a schematic representation of an example of a radio access network RANₙ that may include one or more base stations gNB₁ to gNB₅ (gNB=next generation Node B), each serving a specific area surrounding the base station schematically represented by respective cells 106₁ to 106₅. The base stations are provided to serve users within a cell. The one or more base stations may serve users in licensed and/or unlicensed bands. The term base station, BS, refers to a gNB in 5G networks, an eNB in UMTS/LTE/LTE-A/LTE-A Pro, or just a BS in other mobile communication standards. A user may be a stationary device or a mobile device. The wireless communication system may also be accessed by mobile or stationary IoT (Internet of Things) devices which connect to a base station or to a user. The mobile devices or the IoT devices may include physical devices, ground based vehicles, such as robots or cars, aerial vehicles, such as manned or unmanned aerial vehicles, UAVs, the latter also referred to as drones, buildings and other items or devices having embedded therein electronics, software, sensors, actuators, or the like as well as network connectivity that enables these devices to collect and exchange data across an existing network infrastructure. FIG. 11(b) shows an exemplary view of five cells, however, the RANₙ may include more or less such cells, and RANₙ may also include only one base station. FIG. 11(b) shows two users UE₁ and UE₂, (UE=User Equipment) also referred to as user equipment, UE, that are in cell 106₂ and that are served by base station gNB₂. Another user UE₃ is shown in cell 106₄ which is served by base station gNB₄. The arrows 108₁, 108₂ and 108₃ schematically represent uplink/downlink connections for transmitting data from a user UE₁, UE₂ and UE₃ to the base stations gNB₂, gNB₄ or for transmitting data from the base stations gNB₂, gNB₄ to the users UE₁, UE₂, UE₃. This may be realized on licensed bands or on unlicensed bands. Further, FIG. 11(b) shows two IoT devices 110₁ and 110₂ in cell 106₄, which may be stationary or mobile devices. The IoT device 110₁ accesses the wireless communication system via the base station gNB₄ to receive and transmit data as schematically represented by arrow 112₁. The IoT device 110₂ accesses the wireless communication system via the user UE₃ as is schematically represented by arrow 112₂. The respective base stations gNB₁ to gNB₅ may be connected to the core network 102, e.g. via the S1 interface, via respective backhaul links 114₁ to 114₅, which are schematically represented in FIG. 11(b) by the arrows pointing to “core”. The core network 102 may be connected to one or more external networks. The external network may be the Internet or a private network, such as an intranet or any other type of campus networks, e.g. a private WiFi or 4G or 5G mobile communication system. Further, some or all of the respective base stations gNB₁ to gNB₅ may be connected, e.g. via the S1 or X2 interface or the XN interface in NR (New Radio), with each other via respective backhaul links 116₁ to 116₅, which are schematically represented in FIG. 11(b) by the arrows pointing to “gNBs”. A sidelink channel allows direct communication between UEs, also referred to as device-to-device, D2D (Device to Device), communication. The sidelink interface in 3GPP (3G Partnership Project) is named PC5 (Proximity-based Communication 5).

For data transmission a physical resource grid may be used. The physical resource grid may comprise a set of resource elements to which various physical channels and physical signals are mapped. For example, the physical channels may include the physical downlink, uplink and sidelink shared channels, PDSCH (Physical Downlink Shared CHannel), PUSCH (Physical Uplink Shared Channel), PSSCH (Physical Sidelink Shared Channel), carrying user specific data, also referred to as downlink, uplink and sidelink payload data, the physical broadcast channel, PBCH (Physical Broadcast Channel), carrying for example a master information block, MIB, and one or more of a system information block, SIB, one or more sidelink information blocks, SLIBs, if supported, the physical downlink, uplink and sidelink control channels, PDCCH (Physical Downlink Control Channel), PUCCH (Physical Uplink Control CHannel), PSCCH (Physical Sidelink Control Channel), the downlink control information, DCI, the uplink control information, UCI, and the sidelink control information, SCI, and physical sidelink feedback channels, PSFCH (Physical sidelink feedback channel), carrying PC5 feedback responses. Note, the sidelink interface may support a 2-stage SCI (Speech Call Items). This refers to a first control region comprising some parts of the SCI, and, optionally, a second control region, which comprises a second part of control information.

For the uplink, the physical channels may further include the physical random-access channel, PRACH (Packet Random Access Channel) or RACH (Random Access Channel), used by UEs for accessing the network once a UE synchronized and obtained the MIB and SIB. The physical signals may comprise reference signals or symbols, RS, synchronization signals and the like. The resource grid may comprise a frame or radio frame having a certain duration in the time domain and having a given bandwidth in the frequency domain. The frame may have a certain number of subframes of a predefined length, e.g. 1 ms. Each subframe may include one or more slots of 12 or 14 OFDM symbols (OFDM=Orthogonal Frequency-Division Multiplexing) depending on the cyclic prefix, CP, length. A frame may also include of a smaller number of OFDM symbols, e.g. when utilizing a shortened transmission time interval, sTTI (slot or subslot transmission time interval), or a mini-slot/non-slot-based frame structure comprising just a few OFDM symbols.

The wireless communication system may be any single-tone or multicarrier system using frequency-division multiplexing, like orthogonal frequency-division multiplexing, OFDM, or orthogonal frequency-division multiple access, OFDMA (Orthogonal frequency-division multiple access), or any other IFFT-based signal (IFFT=Inverse Fast Fourier Transformation) with or without CP, e.g. DFT-s-OFDM (DFT=discrete Fourier transform). Other waveforms, like non-orthogonal waveforms for multiple access, e.g. filter-bank multicarrier, FBMC, generalized frequency division multiplexing, GFDM, or universal filtered multi carrier, UFMC, may be used. The wireless communication system may operate, e.g., in accordance with the LTE-Advanced pro standard, or the 5G or NR, New Radio, standard, or the NR-U, New Radio Unlicensed, standard.

The wireless network or communication system depicted in FIG. 11 may be a heterogeneous network having distinct overlaid networks, e.g., a network of macro cells with each macro cell including a macro base station, like base stations gNB₁ to gNB₅, and a network of small cell base stations, not shown in FIG. 11, like femto or pico base stations. In addition to the above described terrestrial wireless network also non-terrestrial wireless communication networks, NTN, exist including spaceborne transceivers, like satellites, and/or airborne transceivers, like unmanned aircraft systems. The non-terrestrial wireless communication network or system may operate in a similar way as the terrestrial system described above with reference to FIG. 11, for example in accordance with the LTE-Advanced Pro standard or the 5G or NR, new radio, standard.

In mobile communication networks, for example in a network like that described above with reference to FIG. 11, like an LTE or 5G/NR network, there may be UEs that communicate directly with each other over one or more sidelink, SL, channels, e.g., using the PC5/PC3 interface or WiFi direct. UEs that communicate directly with each other over the sidelink may include vehicles communicating directly with other vehicles, V2V communication, vehicles communicating with other entities of the wireless communication network, V2X communication, for example roadside units, RSUs, or roadside entities, like traffic lights, traffic signs, or pedestrians. An RSU may have a functionality of a BS or of a UE, depending on the specific network configuration. Other UEs may not be vehicular related UEs and may comprise any of the above-mentioned devices. Such devices may also communicate directly with each other, D2D communication, using the SL channels.

In a wireless communication network, like the one depicted in FIG. 11, it may be desired to locate a UE with a certain accuracy, e.g., determine a position of the UE in a cell. Several positioning approaches are known, like satellite-based positioning approaches, e.g., autonomous and assisted global navigation satellite systems, A-GNSS, such as GPS, mobile radio cellular positioning approaches, e.g., observed time difference of arrival, OTDOA, and enhanced cell ID, E-CID, or combinations thereof.

### SUMMARY

An embodiment may have a user equipment (UE) including a transceiver for exchanging data supporting life cycle management (LCM) of machine learning model (ML model) and being configured to identify one or more landmarks to obtain one or more parameters on the one or more landmarks; wherein identifying includes determining the one or more parameters on the one or more landmarks based on the data supporting the life cycle management (LCM), the one or more parameters describe at least a presence of the one or more landmarks; wherein the one or more parameters or an information derived from the one or more parameters is transmitted by the transceiver as part of exchanging data or wherein based on the one or more parameters an information is derived and/or a trigger is obtained or an utilizing the one or more landmarks is performed.

Another embodiment may have a network entity including a transceiver for exchanging data supporting life cycle management of a machine learning model and being configured to initiate identification of one or more landmarks of the machine learning model, such that a UE can obtain one or more parameters on the one or more landmarks; wherein exchanging data includes transmitting data supporting life cycle management (LCM) and used by an user equipment to identify the one or more landmarks and/or to obtain one or more parameters on the one or more landmarks.

Another embodiment may have a system including an inventive user equipment and an inventive network entity.

According to another embodiment, a method for supporting life cycle management (LCM) of machine learning model (ML model) may have the following steps: exchanging data supporting life cycle management (LCM) of machine learning model (ML model) and identifying one or more landmarks to obtain one or more parameters on the one or more landmarks; wherein identifying includes determining the one or more parameters on the one or more landmarks based on the data supporting life cycle management (LCM), the one or more parameters describe at least a presence of the one or more landmarks; wherein the one or more parameters or an information derived from the one or more parameters is transmitted by the transceiver as part of exchanging data or wherein based on the one or more parameters an information is derived and/or a trigger is obtained or an utilizing the one or more landmarks is performed.

According to another embodiment, a method for supporting life cycle management (LCM) of machine learning model (ML model) may have the following steps: supporting life cycle management (LCM) of machine learning model (ML model) and identifying one or more landmarks to obtain one or more parameters on the one or more landmarks; wherein identifying includes determining the one or more parameters on the one or more landmarks based on the data supporting life cycle management (LCM), the one or more parameters describe at least a presence of the one or more landmarks; wherein based on the one or more parameters an information is derived and/or a trigger is obtained or wherein the one or more parameters or an utilizing the one or more landmarks is performed or an information derived from the one or more parameters is transmitted by the transceiver.

According to another embodiment, a method for performing life cycle management, may have the following steps: exchanging data supporting the life cycle management of a machine learning model and initiating identification of one or more landmarks of the machine learning model based on the data supporting life cycle management (LCM), such that a UE can obtain one or more parameters on the one or more landmarks.

Another embodiment may have a non-transitory digital storage medium having a computer program stored thereon to perform any of the inventive methods when said computer program is run by a computer.

### EMBODIMENTS—GENERAL

Embodiments provide a user equipment (UE) comprising a transceiver for exchanging data supporting life cycle management (LCM) of machine learning model (ML model) and being configured to identify one or more landmarks for/of the machine learning model to obtain one or more parameters on the one or more landmarks; wherein exchanging data comprises receiving a configuration (or pre-configuration) from one or more network entities (NW, RAN, OTT, server), the configuration indicating information on the one or more landmarks or criteria to identify the one or more landmarks; identifying the one or more landmarks is based on information included by the configuration; identifying comprises determining the one or more parameters on the one or more landmarks, the one or more parameters describe at least a presence of the one or more landmarks; the one or more parameters or an information derived from the one or more parameters is transmitted by the transceiver as part of exchanging data or wherein based on the one or more parameters an information is derived and/or a trigger is obtained or an utilizing the one or more landmarks is performed.

Embodiments provide user equipment (UE) for supporting life cycle management (LCM) of machine learning model (ML model) and being configured to identify one or more landmarks of the machine learning model to obtain one or more parameters on the one or more landmarks; wherein the user equipment (UE) comprises an configuration (or pre-configuration), the configuration indicating information on the one or more landmarks or criteria to identify the one or more landmarks; identifying the one or more landmarks is based on information included by the configuration; identifying comprises determining the one or more parameters on the one or more landmarks, the one or more parameters describe at least a presence of the one or more landmarks; based on the one or more parameters an information is derived and/or a trigger is obtained or wherein the one or more parameters or an utilizing the one or more landmarks is performed or an information derived from the one or more parameters is transmitted by the transceiver.

According to embodiments, the information derived comprise an information on validation or test result. According to embodiments, the transmitted information comprises a report.

According to embodiments, identifying is initiated by a user command; alternatively identifying is triggered by the network to search for the one or more landmarks or wherein the transceiver receives information regarding conditions when a UE shall perform an action on the one or more landmarks.

According to embodiments, the transceiver receives configuration information or assistance data supporting the detection of the one or more landmarks. According to embodiments, the transceiver receives a request from the network information on a detected landmark.

According to embodiments, the UE reports the measurements performed on the positioning reference signals together with the position derived from the landmark, or the relative position to the landmark to the network.

According to embodiments, the one or more parameters comprise additionally at least one of:
position of the UE or the identified one or more landmarks;
information obtained from or associated with the one or more landmarks;
relative position to the one or more identified landmarks;
distance to the one or more identified landmarks;
direction with respect to the one or more identified landmarks;
angular information of the user equipment;
identifier derived from the landmark;
additional sensor data obtained using a sensor of the UE during identifying;
additional RF data received during identifying using the transceiver.

For example, the one or more parameters comprise parameters to be used as ground truth label.

According to embodiments, the UE is configured to determine a relative positioning to one or more identified landmarks in addition to the position of the landmark and/or identifier derived from the landmark.

According to embodiments, the UE is configured to determine a quality value for the relative position; wherein the quality depends on the between the UE environmental conditions and the landmark, landmark condition and/or sensor quality used to determine the relative position.

According to embodiments, the UE is configured to determine a parameter quality on the accuracy of the identified and/or estimated parameters. According to embodiments, the UE is configured to determine a quality value on the detectability and/or certainty of the landmark. According to embodiments, the configuration comprise conditions for utilizing the landmarks; the conditions comprise at least one of applicable functionality, applicable RRC configuration and/or model pairing ID; and/or wherein the conditions comprise information on generating ground truth label when a landmark is identified.

According to embodiments further comprising sensor means (e.g. camera, sonic sensor, RFID sensor, NFC etc.) configured to identify the landmark and/or the one or more parameters; alternatively the transceiver is used as sensor means for determining the one or more parameters.

According to embodiments, further comprising an additional sensor, like RADAR, Vision (e.g. Camera), Audio, IMU, GNSS, position, or LIDAR to determine the one or more parameters. According to embodiments user equipment is configured to associate the one or more parameters with the one or more landmarks, e.g. based on a time correlation (offset dependent on UE speed.

According to embodiments, the UE is configured (or pre-configured) to measure or to determine a report measurements or sensor information related to the landmark to the network or wherein the UE is authorized by the network to report measurements related to the positioning reference signals to the entity controlling the sensor related to the landmark detection and related measurements; note the measurements on the positioning reference signal is performed at a position assignable to the measurements related to the one or more landmark; According to embodiments the UE is configured to determine a deviation with respect to space and/or time of the to the one or more identified landmarks from an expectation as parameter (and/or matching indicator).

According to embodiments, the transceiver is configured to operate with 5G signaling in a mobile network (in combination with sensors the UE); alternatively the transceiver is configured to operate with 5G signaling supporting the LCM and/or used for identifying of the landmarks.

According to embodiments, the configuration refers to one or more landmarks in the current surrounding of the UE.

### Network-Side Life Cycle Monitoring

According to embodiments the user equipment is configured to perform in response to receiving one of the following steps:
notifying a network entity with configuration;
receiving capability requests;
providing capability information, e.g., about sensor capability, positioning
informing the NW on the one or more applied sensors
receiving report configuration;
receiving condition on operation and/or data collection;
performing measurement for, reporting on or transmitting the one or more parameters.

According to embodiments, one network entity is configured to perform life cycle management of the ML model, wherein life cycle management comprises one of the following monitoring, updating, verifying, training, testing and/or maintaining the ML model.

According to embodiments, the inference model is deployed at the network entity, wherein the UE is configured to provide parameters derived or associated with the landmark for the ML monitoring, or data collection, or ML model training.

### User Side Life Cycle Management

According to embodiments the user equipment is configured to perform in response to the receiving one of the following:
receiving AD to determine the expected UE model inference output;
reporting on data validity;
notifying monitoring event;
reporting on monitoring metrics of the ML model;
training, verifying, updating, maintaining, testing and/or validating the ML model;
providing a report comprising landmark ID and/or position of the user equipment.

According to embodiments the user equipment comprises a processor configured to train and/or monitor and/or validate and/or test and/or update and/or maintain the ML model based on the identified one or more landmarks and/or the one or more parameters; and/or

wherein the user equipment comprises a processor configured to perform life cycle management of the ML model, wherein life cycle management comprises one of the following monitoring, updating, verifying, training, testing and/or maintaining the ML model.

According to embodiments the user equipment is configured to perform in response to identifying one of the following:
triggering an action or a lower layer action or high layer action based on the trigger;
triggering to transmit and/or the measurements on a position reference signal, if the one or more landmark is detected and/or requesting the related measurement results;
performing measurement using one or more sensors and/or the transceiver of the user equipment;
reporting a one or more parameters associated with the one or more identified landmark;
performing validation based on the one or more parameters and a ground truth label;
performing training based on the one or more parameters and a ground truth label;
transmitting a reference signal or receiving a reference signal;
reporting on measurements performed during identifying; and/or
generating a user equipment position; and/or
performing life cycle management of the ML model comprising one of monitoring, updating, verifying, testing, maintaining.

According to embodiments, the one or more landmarks are out of the group comprising one of the following:
visual landmarks;
landmarks determined using camera or a lidar;
QR code as landmark;
acoustic landmark;
RF landmark;
RFID landmark;
landmark determined using a transceiver.

According to embodiments, the transceiver is configured to provide the network entity information about the additional sensor capabilities. According to embodiments the transceiver is configured to provide information on the sensor like quality, class or category or device information enabling network entity to derive the sensor quality, class or category information. According to embodiments the transceiver is configured to provide receive configuration the according to the UE sensor capabilities, wherein the configuration includes one or more landmarks are out of the group supported by the UE.

According to embodiments, the landmarks are out of the group comprising unique landmarks, general landmarks and/or temporal landmarks.

According to embodiments, the one or more landmarks comprise a ground truth label, like a location dependent information and/or orientation dependent information; the UE may be configured to extract ground truth label from the one or more landmarks; the UE may use the one or more landmarks as a ground truth label or as reference points.

According to embodiments, the one or more parameters comprise a ground truth information, such as the orientation of the UE with respect to the QR code, rough distance to the QR code, NFC measurement, RF measurement, GNSS measurement, RF signal exchanged with TRP, sidelink communication exchanged with TRP, downlink positioning reference signal, side link positioning reference signal, channel state information reference signal; and/or demodulation reference signal.

According to embodiments, the UE is configured to generate one or more additional labels (relative to this reference point) or training data; here UE is configured to generate ground truth labels or training data (e.g. in response to network request). UE may be configured to generate one or more additional labels or training data relative to the one or more landmarks.

Embodiments provide a network entity comprising a transceiver for exchanging data supporting life cycle management of a machine learning model and being configured to initiate identification of one or more landmarks of the machine learning model, such that a UE can obtain one or more parameters on the one or more landmarks; note exchanging data comprises transmitting a configuration to a UE, the configuration indicating information on the one or more landmarks or a criteria to identify the one or more landmarks and receiving one or more parameters or and information derived from the one or more parameters from the user equipment.

Embodiments provide a system comprising a user equipment and network entity.

Embodiments provide, a method for supporting life cycle management (LCM) of machine learning model (ML model), comprising the following steps:
exchanging data supporting life cycle management (LCM) of machine learning model (ML model) and
identifying one or more landmarks of the machine learning model to obtain one or more parameters on the one or more landmarks;

Note exchanging data comprises receiving a configuration (or pre-configuration) from one or more network entities (NW, RAN, OTT, server), the configuration indicating information on the one or more landmarks or criteria to identify the one or more landmarks; wherein identifying the one or more landmarks is based on information included by the configuration; wherein identifying comprises determining the one or more parameters on the one or more landmarks, the one or more parameters describe at least a presence of the one or more landmarks; wherein the one or more parameters or an information derived from the one or more parameters is transmitted by the transceiver as part of exchanging data or wherein based on the one or more parameters an information is derived and/or a trigger is obtained or an utilizing the one or more landmarks is performed.

Embodiments provide a method for supporting life cycle management (LCM) of machine learning model (ML model), comprising the following steps:
supporting life cycle management (LCM) of machine learning model (ML model) and
identifying one or more landmarks of the machine learning model to obtain one or more parameters on the one or more landmarks.

Note the user equipment (UE) comprises an configuration (or pre-configuration), the configuration indicating information on the one or more landmarks or criteria to identify the one or more landmarks; wherein identifying the one or more landmarks is based on information included by the configuration; wherein identifying comprises determining the one or more parameters on the one or more landmarks, the one or more parameters describe at least a presence of the one or more landmarks; wherein based on the one or more parameters an information is derived and/or a trigger is obtained or wherein the one or more parameters or an utilizing the one or more landmarks is performed or an information derived from the one or more parameters is transmitted by the transceiver.

Embodiments provide a method for performing life cycle management, comprising the following steps:
exchanging data supporting the life cycle management of a machine learning model and
initiating identification of one or more landmarks of the machine learning model, such that a UE can obtain one or more parameters on the one or more landmarks;

Note exchanging data comprises transmitting a configuration to a UE, the configuration indicating information on the one or more landmarks or a criteria to identify the one or more landmarks and receiving one or more parameters or and information derived from the one or more parameters from the user equipment.

The method can be computer implemented.

### BRIEF DESCRIPTION OF THE DRAWINGS

Embodiments of the present invention will be detailed subsequently referring to the appended drawings, in which:

FIG. 1 exemplarily illustrates model/functionality relation within 3GPP discussions to discuss embodiments.

FIG. 2a, 2b show example of QR generated label in (a) and Camera+Lidar labels in (b) according to embodiments;

FIG. 3 shows an example for general landmarks representing a wall blocker, a diffraction surface and a moving scatter according to embodiments;

FIG. 4a exemplarily illustrates NW-sided validation for landmarks according to embodiments;

FIG. 4b illustrates UE-sided LCM for landmarks according to embodiments;

FIG. 5 illustrates exemplarily the signaling for generating landmarks according to embodiments;

FIG. 6 exemplarily illustrates an embodiment involving UE-A and UE-B/C/D cooperate with other UEs;

FIG. 7a, 7b exemplarily illustrate alignment of ground truth obtained by application layer processing (e.g. based on optical QR code, traffic signs or based on other reference systems) using application server located in data network according to embodiments;

FIG. 7c exemplarily illustrates alignment of ground truth, measurement and so on at the UE and transmitted using existing protocols according to embodiments;

FIG. 8 illustrates entities functionality for utilizing the landmarks in the LCM according to embodiments;

FIG. 9a landmark assisted high accuracy ground truth labels in complex environments according to embodiments;

FIG. 9b exemplarily shows representation of 3GPP network depicting representative functional blocks to illustrate embodiments;

FIG. 10 exemplarily shows the interaction between different entities of a communication network, e.g. 5g to illustrate embodiments;

FIG. 11a, 11b illustrate examples of a UE and communication network to be used in to illustrate embodiments; and

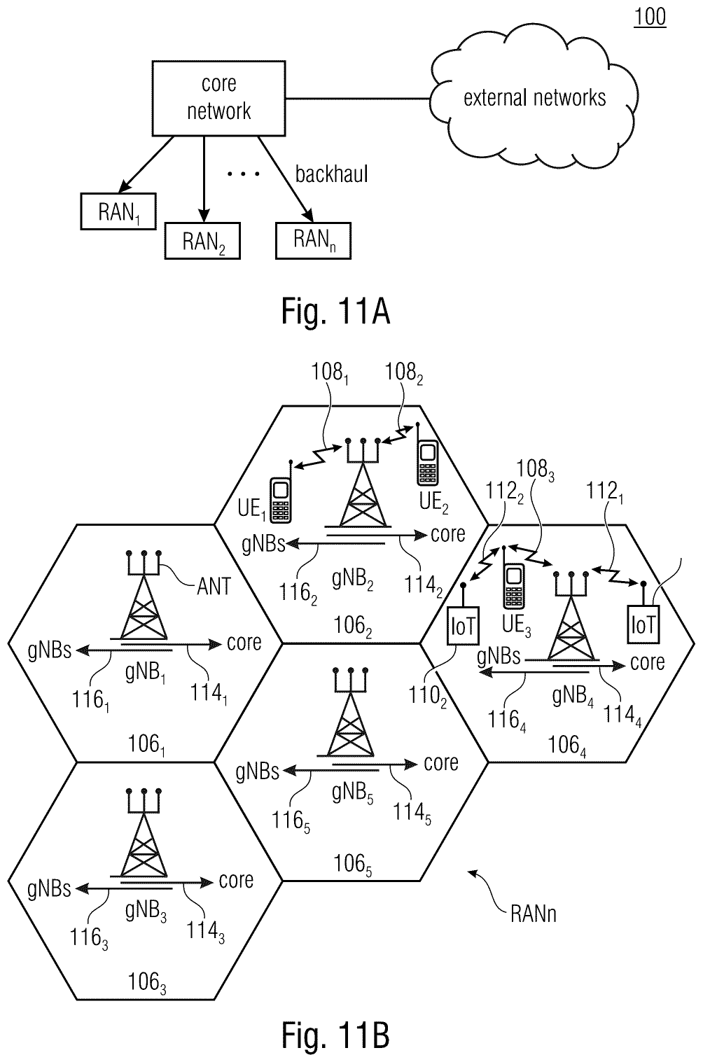

FIG. 12 an example of a computer implementation to be used in to illustrate embodiments;

### DETAILED DESCRIPTION OF THE INVENTION

Before discussion embodiments of the present invention the background will be discussed.

### Background

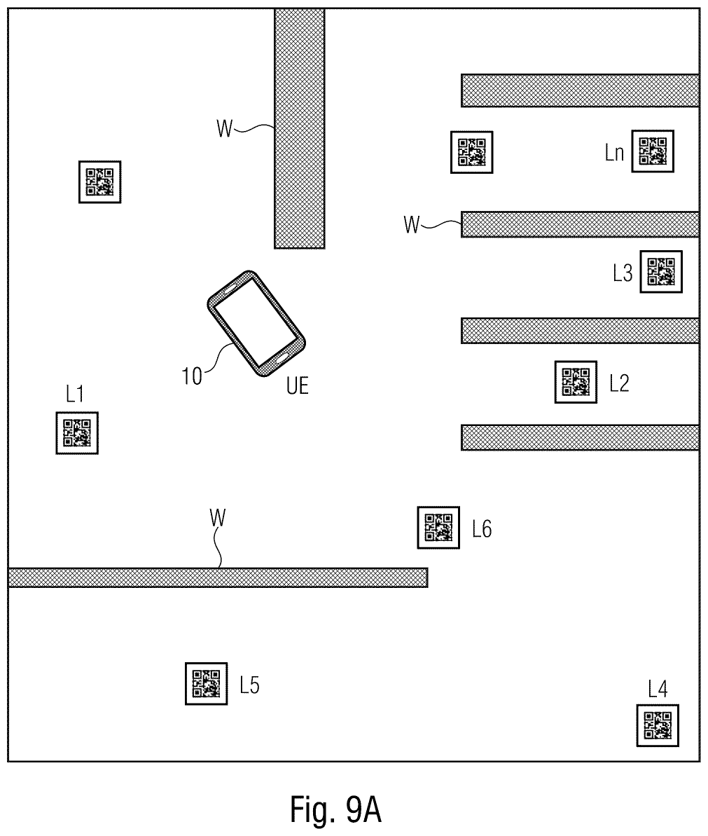

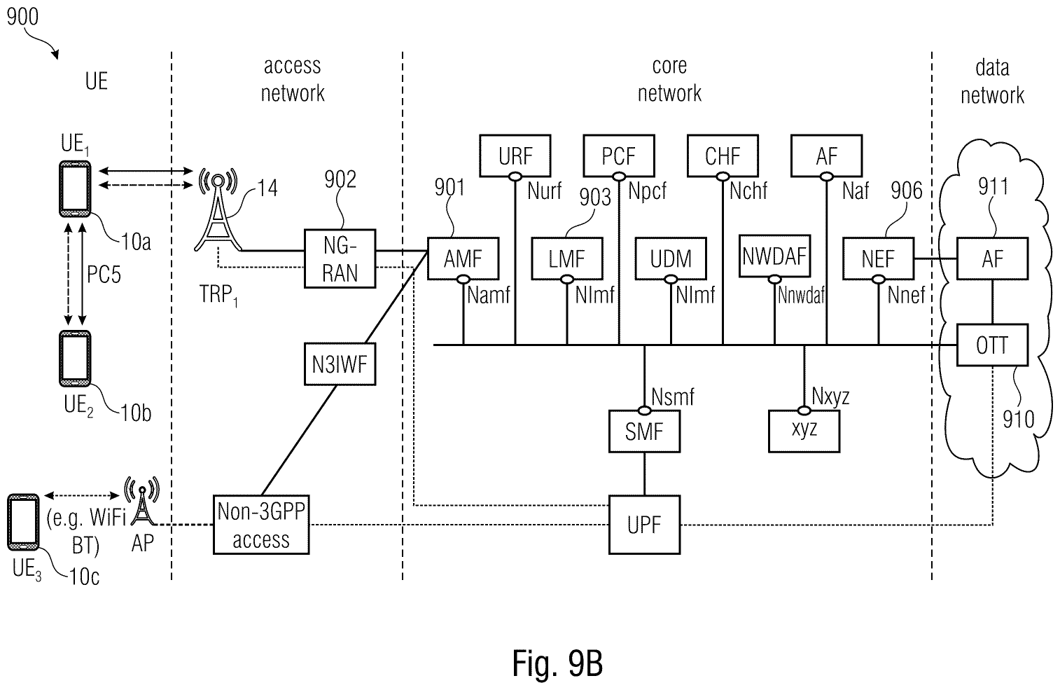

Embodiments are in context of data collection for model training for AI/ML based positioning (cf. FIG. 9a) and generating ground truth labels from UE 10 or network using RAT-dependent or independent positioning methods.

FIG. 9a shows a UE 10 being arranged in a space having a plurality of walls W. Here, some landmarks L1 to LN are illustrated which are arranged around the UE 10 under LOS conditions or also under NLOS conditions, i.e., behind a wall W. The UE 10 can determine the landmarks L1 to LN and/or the respective condition so as to train the model and/or determine the ground truth. Here, the following terms are used:
Ground truth label
   At least for model training
   Report from the label data generation entity
   Ground truth labels according to a proposal are generated by the UE 10 or the network obtained by RAT dependent or independent positioning methods.
   Ground truth labels generated by the UE and network is profitable in the following scenarios:
   Different positioning parameters: RAT dependent methods can operate with different parameters than ML models. Let's assume multiple UEs has different DL-PRS BW capabilities: A UE can for example utilize DL-PRS with a very high bandwidth in FR2 or with carrier aggregation. Meanwhile, the ML model can be operating at much less bandwidth in FR1. That said, this reasoning applies under LOS conditions (cf. L1, L6).
   Future proof: sidelink positioning will be introduced in Rel-18. Sidelink will enable more accurate ground truth labels in complex environments.
   High accuracy labels: Despite the above reasoning, the arguments against UE/Network generated ground truth labels are valid. In fact the major problem to enable AI/ML direct positioning is data collection especially for multipath and NLOS heavy scenarios (cf. L5). Landmarks which can be detected with a high accuracy using a UE onboard sensor can provide high accuracy labels in such scenarios.
Measurement (corresponding to model input)
   At least for model training
   Report from the measurement data generation entity
Quality indicator
   For and/or associated with ground truth label and/or measurement at least for model training
   Report from the label and/or the measurement data generation entity and/or as request from a different (e.g., data collection, etc.) entity
RS configuration(s)
   At least for deriving measurement
   Request from data generation entity (UE/PRU/TRP) to LMF and/or as LMF assistance signaling to UE/PRU/TRP
   Note1: there may not be any enhancements on top of existing RS configuration(s) or any new RS configuration(s) for positioning measurement
Time stamp
   At least for and/or associated with training data for model training
      Separate time stamp for measurement and ground truth label, when measurement and ground truth label are generated by different entities
   Report from data generation entity together with training data and/or as LMF assistance signaling
   Note2: there may not be any enhancements on top of time stamp in existing positioning measurement report or any new time stamp report for positioning measurement
FFS other needed information (e.g., scenario identifier. LOS/NLOS condition, timing error, etc.) for data collection
Note3: whether the above information can be applied to other aspects of AI/ML LCM (e.g., updating, monitoring, etc.) can also be discussed
Note4: transfer of data from the entity generating data to a different entity is not precluded from RAN1 perspective

According to conventional technology, different types of Machine Learning (ML) are distinguish
Supervised Learning: A set of input data (“features”, measurements) is provided together with “labels” (in case of positioning the position) as training data to the model.
Unsupervised Learning: where the algorithm learns to identify patterns and relationships in data without explicit guidance or labels.

After the training phase the model is deployed and shall generate outputs based on the input data (in case of positioning the estimated position).

If the model is deployed a continuous monitoring may be needed to ensure that the model is still valid. In case of positioning reference devices (with known position) may be used and the position estimated by the model is compared with the known position. In case of mismatch the model may need an update.

Furthermore, a continuous update of the model may be possible by providing additional training data. The additional training data may consolidate the model or may extend the coverage area. For examples, for some areas no training data were available during the initial training phase.

Machine Learning (ML) is still being studied within the context of the 3GPP standards. Data collection for generating ground truth label or data validation is being restricted on positioning reference devices or defined communication conditions.

Landmarks are introduced in the context of Augmented Reality (AR) and robotics with SLAM. Especially with the help of these systems, which its environment operate with local or no communication, will support the LCM of 5G communications and positioning.

In the context of 5G standardization PRU (positioning reference units) are defined. A PRU is a device with known position able to perform measurements in 5G signals or transmitting 5G signals.

Compared to this a landmark may be an object with known position, but not able to exchange information with a network.

### Problem Statement

For ML/AI based positioning typically a second positioning system is needed generating the “labels” (“ground truth data/labels”) for the training data. Examples for the second positioning system are:
Robots (or Automated Guided Vehicle (AGV)) able to maneuver to a predefined position.
Manual definition of the position
Other positioning system (in case of outdoor application GNSS, for example)

The collection of the training data using this second positioning system may be time consuming or expensive. Furthermore, a continuous monitoring or update of the model may be needed. Accordingly additional information on the position of a device at least for selected positions may be beneficial for monitoring or update of the model.

Taking inaccurate or unreliable ground truth labels (GTL) for machine learning can cause reduced model accuracy since Ground truth labels are essential for supervised learning. If the labels are not accurate, the machine learning model will learn incorrect patterns and make inaccurate predictions. Inaccurate labels can distort the performance of positioning applications using the machine learning model.

An additional important aspect is the model generalization, models trained on inaccurate labels (which may not cover a given realistic scenario) may not generalize well to new data, as the model will be trained to recognize incorrect patterns that may not be present in new data. This can be for example, that model was trained with data from an Automated Guided Vehicle (AGV) meanwhile the application is handheld smartphone. Means for collecting “real” data needs to be defined to verify, clean or update the data collection for the model. In ML models running within mobile framework such as 5G framework, ground truth labels that can be mapped to a geographical, environmental or channel characteristics are important for communication and positioning uses cases.

For example for direct positioning, the positioning accuracy achievable by the AI/ML method can lead to worsen performance if low quality GTLs are used. For this reason utilizing GTLs based on existing positioning methods such RAT (DL-TDoA, UL-TDoA, RTT, AoA or AoD) or non RAT (such as GNSS are not desired). In a practical example, ML in positioning use cases shall overcome classical approaches in challenging environments when these approaches performs poorly.

Based on the above example, the problem arises on methods to generate reliable labels with high quality to ensure the process of life cycle management in 3GPP networks.

### Life Cycle Management Background

AI/ML Architecture, interfaces and entities are, for example shown by FIG. 9b.

FIG. 9b depicts the components of the 3GPP wireless communication system 900 (or 5G System (5GS)). The system 900 consists of user equipment (UE) 10a, 10b and 10c, access network (AN), core network (CN), and data network (DN). A UE 10a registers itself with the AMF 901 via either the NG-RAN node 902 (such as gNB) using 3GPP defined radio access technology, such as NR or via a non-3GPP access method (such as WiFi) via the non-3GPP interworking function (N3IWF).

The core network contains one or more functions that can interact with each other using the so-called service based architecture using interfaces. As an example, the AMF 901 can send message to LMF 903 via the Nlmf interface and the LMF 903 can send message to AMF 901 using the Namf interface.

In the following, a brief description of the network entities/functions is provided to give a simplified view of the working principle of the core network. In the core network, the AMF (access and mobility function) is the network function through which control plane signaling from the core network are sent to the UE. A UE registers in the network with the AMF. It manages the mobility of user devices and handles access authentication and authorization in the 5G core network. The LMF 903 (location management function) is responsible for determining the location of the UE 10a by interacting with one or more network functions and/or access network nodes and/or the UE and providing the location to the location service client, which may be another application function 911 (AF), an AMF 901, UE 10a, entity in the access network or in the external network. The network exposure function 904 (NEF) exposes the services, capability and/or information to external applications and third-party in a secure and controlled way. There may be an application function in the data network, which may be able to access the information from the 5GS via NEF or directly using the service-based architecture. Network repository function (NRF) provides a centralized repository for network function information in the 5G core network, facilitating the discovery and access of available network functions and their capabilities. Charging function (CHF) manages the charging and billing aspects of user services in the 5G core network, including data usage, service subscriptions, and payment authorization. Policy control function (PCF), controls and manages policy-related decisions and enforcement for Quality of Service (QoS), network resources, and user access in the 5G core network. Unified Data Management (UDM), stores and manages user-related data such as subscriber profiles and authentication credentials in the 5G core network. Unified Data Repository (UDR), serves as a central storage for user-related data in the 5G core network, including subscription and session information. Network data analytics function (NWDAF) collects and analyzes network data, providing insights for network optimization, Quality of Service (QoS) improvements, and resource allocation in the 5G core network. Authentication Server Function (AUSF), handles authentication and security-related functions, including generating authentication vectors and verifying user identities, in the 5G core network. There are, of course, further application functions in the network beyond what is discussed above and the functionality described above is to only give a broad picture of what an application function may do but not to limit the functionality of an application function.

The over the top (OTT) server, which is a application server to which the UE 10a is able to connect using user plane data, depicted in FIG. 9b can be an entity managed by the network or it may be a third party server (e.g. from a vendor). The OTT 910 may acquire information from the 5GS for training the estimator based on performance of the inference device and/or output of the estimator and/or ground truth and/or additional information. It may acquire the information using network exposure interface. For example, a specific UE vendor ‘A’ may be running inference models at the UE which are loaded to the UE via application layer (5G user plane data via 3GPP access network, non-3GPP access network or simply via external data connection (e.g. standalone WiFi). The vendor may be interested in one or more features for training the estimator (for example: UE location computed at the network, or RSRP of the received signal, or block error rate (BLER). The vendor may subscribe to certain information (e.g. ground truth, such as UE location, RSRP, BLER . . . etc) via the NEF of the network. The received data may be provided a unique mechanism to relate data from different sources (e.g. time stamped), so that the OTT can align the information received from the UE with the information received from the network to train data for the model/functionality or train the estimator to predict the performance of the model.

### 5G AI/ML Framework General

In the context of machine learning, life cycle management LCM refers to the end-to-end process of developing, deploying, and maintaining machine learning models. This includes several stages, such as data preparation, model training, testing, deployment, monitoring, and maintenance. For the context of the proposed solution we focus on the stages in the LCM relevant for the landmark utilization.

Data collection is defined in 3GPP Framework as a process of collecting data by the network nodes, management entity, or UE for the purpose of AI/ML model training, data analytics and inference. Data Collection and Preparation involves the collection and preparation of data by the UE, the Network, or outside the network (for example non-3GPP entity). The data is used to train the machine learning model in offline or in real time.

Model Training is defined as a process to train an AI/ML Model by learning the input/output relationship in a data driven manner and obtain the trained AI/ML Model for inference: In this stage, the machine learning model is trained using the prepared data. This involves selecting the right algorithms and optimizing the model's performance.

Model validation is defined subprocess of training, to evaluate the quality of an AI/ML model using a dataset different from one used for model training, which helps selecting model parameters that generalize beyond the dataset used for model training.

Model testing is defined subprocess of training, to evaluate the performance of a final AI/ML model using a dataset different from one used for model training and validation. Differently from AI/ML model validation, testing does not assume subsequent tuning of the model. Model monitoring is defined as a procedure that monitors the inference performance of the AI/ML model. Once the model is deployed, it needs to be continuously monitored to detect any performance degradation or errors. This stage involves tracking model performance metrics, detecting data drift, and retraining the model if needed.

Model Maintenance: the model needs to be maintained and updated over time to ensure its performance remains optimal. This stage involves retraining the model with new data, upgrading its algorithms, and improving its architecture.

For Effective lifecycle management of machine learning models in the mobile networks the proposed solution can be mapped on one or more of the above mentioned stages.

The Framework for AI/ML in 5G considers “proprietary model” and “open-format model” as two separate model format categories. In Proprietary-format models, ML models of vendor-/device-specific proprietary format, from 3GPP/5G perspective (An example is a device-specific binary executable format). In Open-format models, ML models of specified format that are mutually recognizable across vendors and allow interoperability. It is assumes that Proprietary-format models are not mutually recognizable across vendors, hide model design information from other vendors when shared. Additionally open-format models are mutually recognizable between vendors, do not hide model design information from other vendors when shared.

Functionality identification, according to 5G framework is a process/method of identifying an AI/ML functionality for the common understanding between the NW and the UE.

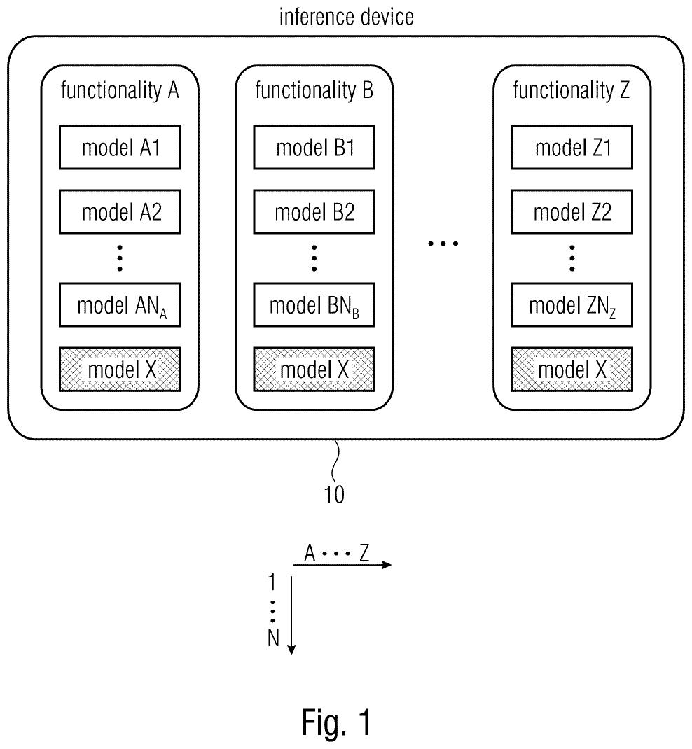

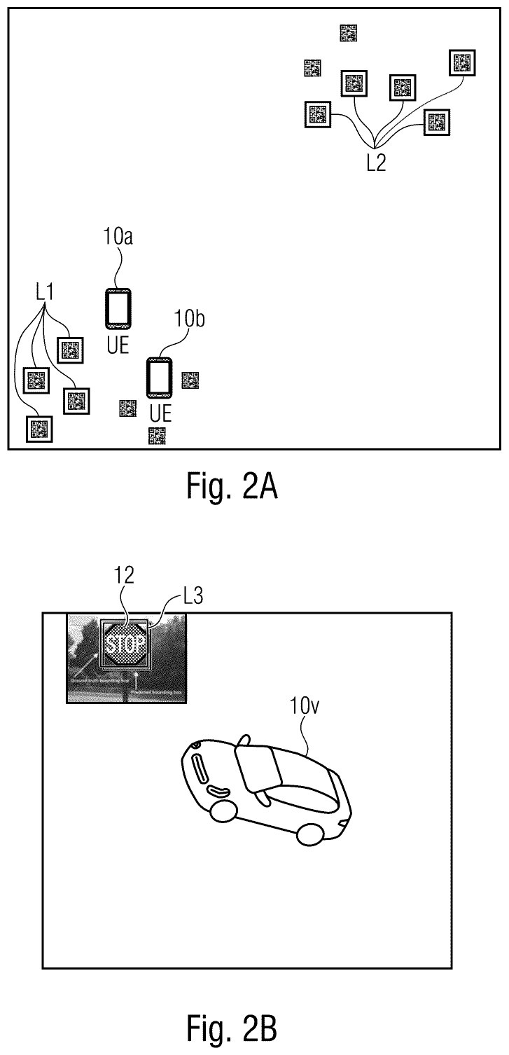

UE may have one AI/ML model for the functionality, or UE may have multiple AI/ML models for the functionality (e.g., see functionalities A, B, Z in FIGS. 1 and 2). Models of the same functionality, albeit maybe different in structure, will have the same input/output/side-information configuration. FIG. 1 shows that a device 10 may use different models 1 to N (Na, Nb, Nc) for different functionalities A, B, etc. Z.

Each model, here the model A may be available in different versions and implementations, respectively.

Alternatively, a more complex model, trained with data from several sites, can implement more than one functionality (e.g., see Model X in FIG. 1). In this case, proper configuration of the model and the signaling between the UE and the NW is needed to handle the different input/output/side-information requirements.

For functionality-based LCM procedure on the UE-part/UE-side models the UE can in one option provide indication of activation/deactivation/switching/fallback based on individual AI/ML functionality. The UE may receive assistance data to enable this functionality. The UE can in an alternating option receive from a second entity, such a coordinating entity, an indication of activation/deactivation/switching/fallback based on individual AI/ML functionality. For the later option the second entity being a network indicates activation/deactivation/fallback/switching of AI/ML functionality via 3GPP signaling (e.g., RRC, MAC-CE, DCI). Model/functionality relation are shown by FIG. 1.

An AI/ML model has a model ID with associated information and/or model functionality at least for some AI/ML operations when network needs to be aware of UE AI/ML models. For model-ID-based LCM procedure, indication of model selection/activation/deactivation/switching/fallback based on individual model IDs.

Model description information or meta information is the supplemental information being provided about a model during model identification process. The model description information can include a list of applicable AI/ML-enabled Feature(s) and/or applicable conditions of the model. The conditions can for example include the applicable functionality/functionalities, applicable RRC configurations, model pairing ID.

### Positioning Use Case

For positioning uses cases in the 5G AI/ML framework for positioning accuracy enhancement Direct and assisted AI/ML positioning are considered.

### Direct AI/ML Positioning:

The output of AI/ML model inference is UE location e.g., fingerprinting based on channel observation as the input of AI/ML model). Accordingly, the “data collection” covers measurements on the received signal. Examples for the measurements are:
Signal power
Channel impulse response (CIR)
Relevant parts of the CIR
Estimated time-of-arrival (ToA) of the first path and/or additional paths
Magnitude of each path
Phase of each path
Angle-of-arrival (AoA) estimates
Angle-of-departure (AoD) estimates

In case of antenna arrays or devices with several antennas measurements for each antenna or for different beams may be provided.

### AI/ML Assisted Positioning:

In this case the AI/ML model will “preprocess” the measurements, whereas the position itself is calculated by other algorithms. The output of AI/ML model inference is new measurement and/or enhancement of existing measurement. Examples are
LOS/NLOS identification,
AoA estimation using a set of measurements
ToA estimation from the CIR
Measurement quality/reliability information,
Correction values (e.g., a first estimator provides a first output. AI/ML may generate one or several additional hypotheses for the measurement value)
Classification of a measurement (identification of parts specular or diffuse reflections, for example).

Landmarks detected with high accuracy using UE onboard sensors can provide more accurate ground truth labels, especially in scenarios with multipath and NLOS conditions, where data collection for direct AI/ML positioning can be challenging.

Proposal to be discussed below: Regarding ground truth label generation for AI/ML based positioning, the UE or Network generates ground truth label when label quality satisfy the requirement:
based on non-NR and/or NR RAT-dependent positioning methods and/or
UE Sensors and scenario defined landmarks

### Solution—Concept

A UE may be able to determine its position relative to a landmark. If the UE has the capability determining its position relative to a landmark a UE can assist the ML model training. Furthermore, a UE capable to calculate its position relative to a landmark can become a PRU. Many technologies exist to calculate the relative position of a UE to a landmark, if the UE is close to the landmark. In this case the UE can provide “labels” with high accuracy (GTL) together with the measurements. Using landmarks instead of PRUs offers the following advantages:
Any UE with the capability providing information on the relative position to the landmark can become a PRU.
Different UE types (UEs from different manufacturer, for example) can be used. Accordingly the impact of the UE characteristics (different antenna characteristics, for example) can be taken into account for the (re-)training of the model.

The UEs may have different positions relative to the landmark. This allows to generate GTLs for several positions, capturing also variations of the channel conditions in an area around the landmark.

A landmark can be any object with known position. This may be a building (the edge of a building, position of entrance, etc., for example), another object which can be identified by the UE camera (a QR code label, for example) or a device which can be detected by technologies not defined by the 5G standard (near-field-communication (NFC), for example) The UE may receive assistant data from the network on available landmarks in an area. Or vice versa if the UE detects an object (a QR-code label, for example) it can “ask the network”, if the position of this landmark is known.

Beside the identification of landmarks and the relative position of the UE relative to the landmark, reliability/quality information may be needed on the accuracy of the GTL to ensure the integrity of the landmark.

Different methods are considered to determine the position relative to the landmark (see chapter 0). Two types of implementation are distinguished:
The LCM process is defined by the standard. In this case the standard defines the related configuration parameters, the measurements, and the reports.
Parts of the LCM process can be implemented using proprietary solutions. In this case interfaces between the different modules have to be supported.

### LCM Process Defined by Standard

A UE capable to measure the position relative to a landmark or capable for forwarding data (e.g., sensor data) to another device calculating the relative position is configured to provide this information if it is close to the landmark or if it identifies a landmark. The UE will forward the information related to the landmark (relative position or sensor data) to the network together with the other measurements performed on 3GPP signals. The network will use this information to monitor or update the AI/ML model.

Different embodiments are considered:
The UE receives information on the position of the landmark from the network or is triggered to “search” landmarks. If the UE is close to the landmark, and/or able to detect a landmark it estimates its position relative to the landmark. Together with the relative position of the UE to the landmark the UE can calculate its position and forwards its position to the network.
The UE may detect a landmark. The UE does not know the position of the landmark. The exact position is only known by the network. The UE and reports the relative position only.
The UE can only assist the relative positioning to the landmark. An example is a UE passing a landmark and the UE can perform distance measurements only. For a moving device and the sequences of distance measurements a trajectory can be estimated and the position on the trajectory is estimated by post-processing of the sequence of measurements.

Furthermore, the UE may be configured by the network to consider landmark information only a given area, whereas the given area may be defined by assistance data using initial position estimate or a cell identifier.

### AI/ML Framework Allows Proprietary Solutions for the LCM

In this case the landmark related measurements may be implemented in the user plane (e.g., an “APP” implements the measurements and position calculation related to the landmark and is able to generate the labels). If the user plane implements the generation of the label, the user plane needs also access to the measurements on the 5G signals used as AI/ML model input. According to this principle the UE has to be authorized (configured) to provide the measurement data (“raw data” or the data as used for the model input) to the user-plane. Using this data the model may be updated and forwarded to the network. The standard has to support “external trained models”.

This embodiment is characterized by:
The UE is able determining its (exact) position independent from 5G signals using a proprietary solution. This proprietary solution may be implemented by an “APP” running on the UE.
This APP may receive assistance information from the 5G system (e.g., initial position estimated)
If the APP detects a landmark, it may trigger the transmission of 5G positioning reference signals (DL-PRS, UL-SRS, SL-PRS or other reference signals useful for positioning) and related measurements on these signals.
The APP may request from the network and/or the UE the measurements. The data may be subject of privacy issues. Accordingly, the UE may need authorization from the network to forward this data to the APP.
The APP reports to a server related to the APP (e.g., an LCM server) the GTLs and related measurements.
Alternatively, the LCM server gets the 5G signal related measurements through the network.

A basic embodiment may be defined as follows:
1—The UE will receive information form the network on or more landmark in a given area.
   a. The information includes conditions on generating ground truth labels when a landmark is identified
   b. The received information can be outside a 3GPP network and hence the message or UE pre-configuration is transparent to the network
2—The UE is configured (subject to capability) to perform an action; related to the a communication or positioning use case; with at least one BS or a second UE based on the conditions in 1, the action includes, one or more of the following:
   a. Transmit a reference signal (UL, DL or/and SL)
   b. receive a reference signal (UL, DL or/and SL)
   c. Report on measurements
   d. Generate a UE position
3—The UE output together with the derived ground truth label is utilized for the life cycle management of a the 5G framework (used for the purpose of ML monitoring, validation or data training collection)
   a. The UE can report the output or apply it directly for the case of UE-based positioning or generally UE-sided models

Using landmarks or RAT (In)dependent methods are two different approaches that have their own advantages and limitations. The advantage of using landmarks is that they can provide highly accurate and reliable position estimates, particularly in environments when RAT (In)dependent methods may be weak or unavailable.

A corresponding method may be defined as follows:

A method performed by a User equipment (UE) for supporting a life cycle management (LCM) for machine learning in mobile networks, the method comprising:
(101) receiving a configuration or a pre-configuration from an entity (NW, RAN, OOT), the configuration indicating information on selected landmarks or a criteria to identify landmarks or conditions for utilizing the landmarks;
(102) identifying by the UE one or more landmarks based on the configuration; and
utilizing the landmark information to support the life cycle management of a the 5G framework (used for the purpose of ML monitoring, validation or data training collection
wherein the identified information in (102) is used for LCM process (Collection Training, validation, testing, monitoring or maintenance)

### Types of Landmarks in an Environment

To generate ground truth labels a known environment with known landmarks is needed. The landmarks can represent markers or objects with known positions in the environment, such as QR codes, markers or known obstacles.

According to embodiment, the UE receives information on the landmarks that can be detected by sensors of the UE. For example, if a UE is capable of utilizing its camera or other vision sensors for detecting visual landmarks then “visual” landmark information can be provided. It should be noted that UEs can be smartphones, vehicles, small IoT device or the similar as supported by the mobile communication system. The capabilities from the UE may be known before providing the landmark information or requested from the UE or derived from the UE type and class.

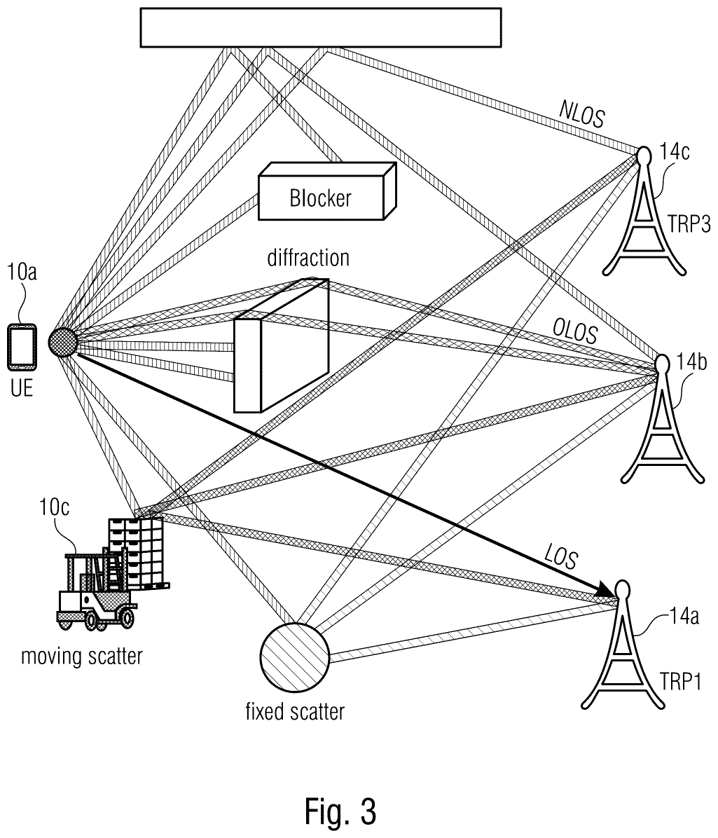

In this regards we distinguish for the solution three types of landmarks, unique landmarks (FIG. 2a, 2b) and General landmarks (FIG. 3):
Unique landmarks: easily distinguishable from other features in the environment and can be used as reference point based on the UE position and/or orientation. Examples are QR codes, visible markers, audio markers, beacons, private/local positioning system (transparent to the network).
General landmarks: represent features in the environment that are not distinctive as the unique landmarks. These landmarks can refer to a characteristic such as a blocker, edge, wall or metallic surfaces. Such features can be detected from Lidar or Radar sensors or vision sensors
Temporal landmarks: example is a moving car acting as a PRU with high accuracy. Other UEs can identify the temporal anchor using the onboard sensors.

It should be noted that multiple landmarks from the same or different types of landmarks may be applicable in the same application.

FIG. 2 (a) shows the limited coverage of landmarks meaning that may not be evenly distributed throughout an environment. FIG. 2a for example the labels L1 are arranged in a lower left corner next to the UEs 10a and 10b, wherein the labels L2 are arranged in the upper right corner of the covered space. This leads to areas with fewer or no landmarks. In a separate example, the environment may include multiple markers, and one or more subset(s) of the landmarks can be provided to the UE. Alternatively the UE may be (pre-) configured with the multiple subsets and activates the landmarks according to conditions of operation defined within the LCM operation.

Ambient IoT (Internet of Things) refers which can be smart devices and sensors that are integrated into our surroundings to collect and transmit data about the environment. Landmarks can be represented by passive Ambient IoT devices, wherein Passive ambient IoT devices are those that collect and transmit data without needing any user input or interaction. Examples are environmental sensors and smart lightning sensors. Landmarks can also be realized by active ambient IoT devices which use data and sensors to take actions and provide services. One example on active ambient IoT landmarks are speakers which can provide acoustic or audible information to be decoded by a UE microphone.

As illustrated by FIG. 2b even a traffic sign 12 may be interpreted as label L3, e.g., when a vehicle 10V (representing a mobile device having communication functions according to embodiments) captures the sign 12 and labels same with label L3.

Further examples on landmarks include reflectors, such as optical reflectors which can assist the UE locate the relative to the landmark by using the signal reflected back toward the UE (cf. FIG. 3). Similar landmark usage can be applied for RF reflecting surfaces (or relays). In FIG. 3 two devices 10a and 10c are illustrated which receive direct and non-direct signals from three transmission points 14a, 14b and 14c. The different communication paths are marked by LOS for Line of Sight, NLOS for Non-Line of Sight, e.g., reflected, and OLOS for Obstructed Line of Sight, e.g., obstructed by a diffraction.

### EXAMPLES

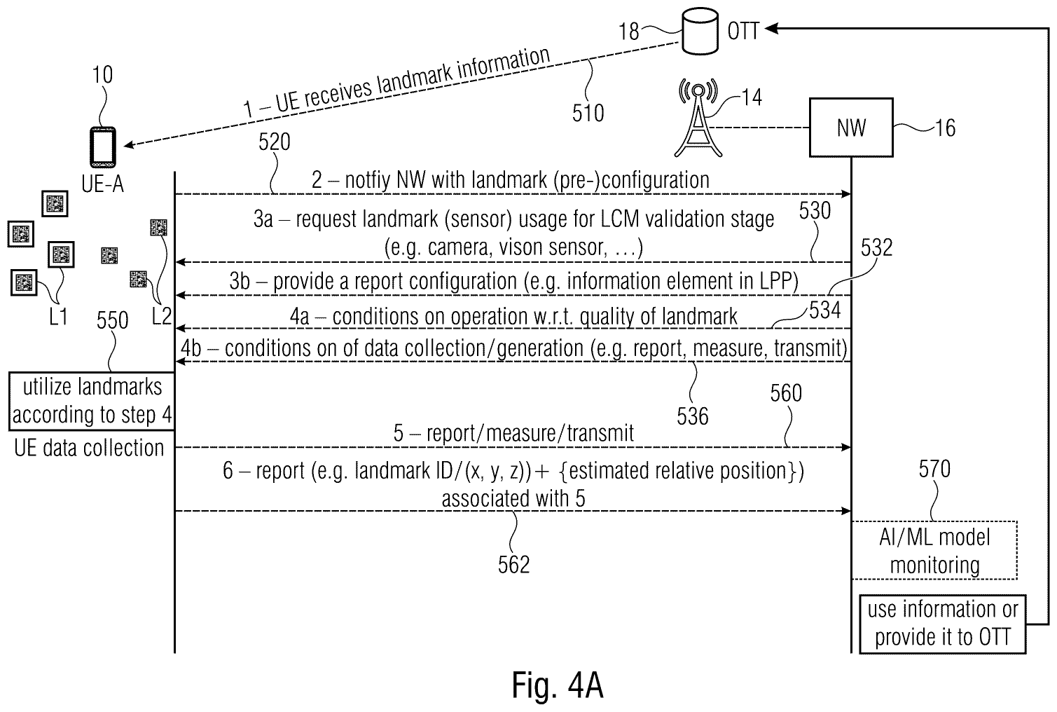

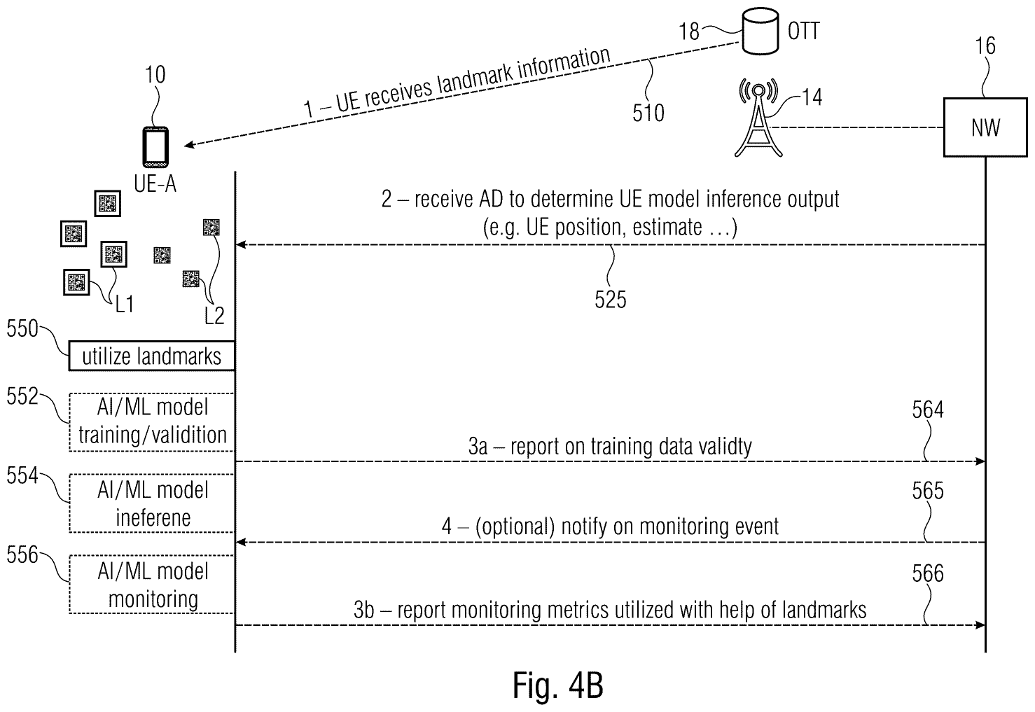

NW-sided validation for landmarks is illustrated by FIG. 4a. FIG. 4a illustrates the interaction between a network 16, e.g., having a transmission point 14 and a UE 10. In the surrounding of the UEs two different labels L1 and L2 are illustrated. The UE 10 receives from the OTT 18 or in general from a network entity a landmark information in step 510. After that the UE 10 may perform notifying NW with landmark pre-configuration as illustrated by the step 520.

In response to this, the network 16 may perform the steps 530 and 532 of requesting landmark to be used for LCM validation stage (cf. 530) and providing a report configuration (cf. 532). Additionally, in the steps 534 and 536 the network 16 may provide conditions on operation with respect to quality of landmark and condition of data collection/generation. Starting from this, the UE 10 is enabled to utilize the landmarks as illustrated by the step 550. At the end of the illustrated method a report/measurement/transmission is performed (cf. step 560 and 562). Based on the report the AI/ML model can be monitored in the step 570. Optionally, this information may be used or provided to the OTT 18 for generating further landmark information.

UE-sided LCM for landmarks is illustrated by FIG. 4b. Here the same entities 10, 14, 16 and 18 are in charge. The method starts with the step 510 together with the step 525. Here the UE 10 receives AD to determine UE model inference output and starts to utilize the landmarks in the step 550. Furthermore, the steps 552 of AI/ML model training and validation, 554 of AI/ML model inference and 556 of AI/ML model monitoring may follow. Starting from the training and validation 552 a report on training data validity in the step 564 may be provided by the UE 10, e.g., to the network 16. Optionally, the network 16 may notify a monitoring event in the step 565. After monitoring 556 the UE 10 may provide a report on monitoring metrics utilized with the help of landmarks in the step 566, e.g., to the network 16.

In both example basic and optional information are exchanged.

### Label Quality Satisfy the Requirement

### Quality Depends on Sensor on Landmark Characteristics

FIG. 2(b) shows that landmarks can be ambiguous and it can be that UE detects it with low quality or even wrongly-detect the marker with what might appear to the sensor a similar obstacle.

### UE Capabilities Reports Related to the Landmarks:

a. On Board Sensors Such as Camera, LIDAR

UE uses this capability to resolve a position or an ID or an information related to a position

### Landmarks Used for Different LCM Stage

Reliable position information is a critical pre-requisite for several stages in the AI/ML model LCM within the 5G network. High-quality ground truth (GT) position labels need specialized equipment or the availability of PRUs, thus extensive GT label collection in different areas and times of day, as well as under different environment and radio conditions, is both hard and expensive. Landmark-enabled GT label collection, allows for much more flexibility in this regard, enabling more informative AI/ML model LCM.

### Model Monitoring

The core aspect that needs this type of flexibility is model monitoring. Here, the input/output and performance characteristics of an AI/ML model are constantly evaluated and in case an indication of possible performance degradation is detected, a decision needs to be made on whether the current active model is sufficient, or another AI/ML model (or a non-AI/ML fallback operation) needs to be activated. A GT label on position, can assist on several ways.

Landmarks can be used to evaluate the performance of the ML model in realistic conditions that were not necessarily considered during training. By using landmarks to generate new data during inference, the performance of the model can be evaluated in real-world scenarios with different UE devices, hand blockage effect, rotation, UE placement conditions (hand, bag, pocket VR, . . . ) and other environmental factors.

In one aspect, the UE (especially for UE-sided models) evaluates the performance associated with an ML model input or/and output and a detected landmark. Alternatively, the UE performs measurements, and/or transmission and/or reporting as configured by the monitoring procedure associated with the landmark. The measurements, and/or transmission and/or reporting allows the NW entity to monitor the ML model performance especially for NW-sided models.

Using the ground truth label to assess the accuracy of the ML model's predictions by evaluating the model performance. Or using the landmark as a reference point to track the performance of the ML model over time. Performance evaluation can for example be performed by comparing the captured data or data distribution with the expected data or by comparing the data to a known location or by using techniques estimate the landmark's position in case of positioning application.

In another example, model monitoring associated with a landmark can operate by triggering the UE to perform a certain action. For the example of beam management, the UE may be configured to perform a Tx or Rx beam sweep (i.e. transmission or reception of Uplink, downlink or sidelink beams in different directions). The same is applicable for other LCM stages such data collection, data update and model training.

In a related aspect, the UE uses the ground truth label extracted from the landmark to evaluate if a performance degradation is detected. A UE can decide to maintain current active model is to activate another AI/ML model or a non-AI/ML fallback operation. Alternatively, the UE or NW can update the model's training data or adjusting model parameters, or even changing its architecture to better fit the data being collected from the landmark.

(Landmarks for) Monitoring of AI/ML Models for Positioning

It goes without saying that a GT label for evaluating the accuracy of an AI/ML model used for direct or indirect positioning is valuable. When there is a request, either in frequent intervals either event-based from the monitoring entity (e.g., there is an alarm raised indicating there could be a potential performance drop in the model) to monitor and ensure the performance of an active AI/ML model, a GT label is needed to be generated/be available for several time-steps. In such ad-hoc requests, the flexibility and coverage of a landmark-based solution is significantly higher compared to a solution that needs PRUs being available at all times.

(Landmarks for) Monitoring of AI/ML Models for Beam Management and CSI Compression (Assisting on Monitoring Decision for Model Re-Training/Fine-Tuning)

A GT position label can also provide critical support for the monitoring decision regarding AI/ML models that perform beam management or CSI compression. Once a performance drop of a BM or CSI-C model is detected, then a full beam sweep or a measurement of all beams in set A is performed (for beam management) or the uncompressed CSI is used (for the CSI-C use case), to evaluate the performance of the model. If the AI/ML model performance is below a threshold, then another model could be activated or a fallback strategy could be applied.

In such a situation, if we have a GT label for the UE position as additional information during monitoring, —assuming that this is also available in the training data—we can infer if the model performance drop is due to changes in the environment. Consider the example of beam management: when we know the UE position during monitoring and record the RSRP values of all beams (or beams in Set A), then we can compare the RSRP pattern with the RSRP values recorded in the training data for UEs in similar positions. If these are different, then we can safely say that the environment has changed. If this mismatch is observed consistently, then the change is permanent and the model needs re-training/fine-tuning, otherwise it was a temporal effect (e.g., a temporal blockage).

### Model Training

Modern AI/ML algorithms need large amounts of data, that have sufficient coverage, meaning they capture all effects in the environment (e.g., data collected in different times of day, at different locations, under different network load conditions, from devices with different capabilities, etc.). For data collection for training AI/ML (direct or assisted) positioning models, the availability and utilization of dedicated PRUs for all these measurements is a challenging and costly task. Landmark-based GT label generation provides far greater coverage and flexibility.

Moreover, as described above, even for data collected for beam management or CSI compression AI/ML model training, can benefit from having the UE position GT label as an information, since it can be utilized at least for model monitoring.

In one approach the UE use a dataset of landmarks with known positions, and then use this data to train an ML model to recognize similar landmarks in new environments. For example, an ML model could be trained to identify a landmark with some unique features of the landmark. This can for example to indicate a need to better recognize and locate similar landmarks in new environments. One example can be or ML positioning assisted is LOS and NLOS classification. The landmark can assist the model in identifying whether a detected link under certain channel condition was a LOS or NLOS.

For ML direct positioning, additional data collected from landmarks can be used to further refine the model's performance and improve its ability to accurately estimate position and/or orientation.

In a different aspect, the UE can use the landmarks as a ground truth labels or reference points. The UE generates additional labels relative to this reference point. The UE can for example move in a known trajectory or report the trajectory using the UE's on board sensors (such as motion sensors). In a more robust approach, the known trajectory can be the path between two or more landmarks. Hence the UE uses coarse Ground truth labels and creates relative to these landmarks finer labels.

Multiple UEs can work together to generate training data relative to a landmark. The UEs can coordinate their movement or one or more UEs share their sensor data. The UEs can also include relative distance information derive labels. The UEs (or the NW) can also identify the relative between the UE by the level of correlation on the channel (e.g. CIR or PDP). The UE (or NW) uses the landmark to map the multi-UE information to a Global or a local coordinate system. This approach can generate a large amount of training data in a short amount of time in multi-UE scenarios.

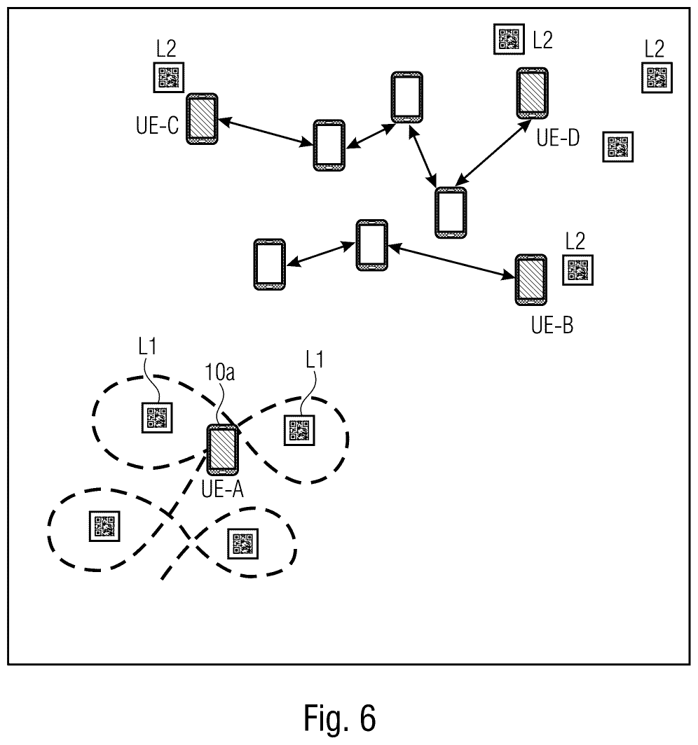

As shown by FIG. 6 UE-A (cf. 10a) generates a labels L1 in a known track relative to the landmarks. UE-B/C/D (cf. 10b, 10c and 10d) cooperate with other UEs 10a, 10b, 10c and 10d) with communication and/or relative positioning or ranging information to generate ground truth labels relative to the landmark L1 and L2.

### Ad-Hoc Queries for Data, Based on Specific Requirements

Another important aspect of the flexibility and coverage of landmarks is the ability to provide GT labels in requests for specific types of data. For example, assume the following two scenarios:
An AI/ML positioning model is no longer performing well in a part of an area that was trained on or under specific conditions in the environment (e.g., FIG. 3). Or a beam management model is not predicting accurately when a specific RSRP measurement pattern appears in Set B measurements.
A new AI/ML (positioning, BM or CSI-C) model is deployed (after being validated and tested under RAN4 tests), but we would like to evaluate its performance in real conditions also, so we enable it to verify that it predicts correctly, while another model is used for the task. Here, we could be interested in specific cases which do not occur frequently in the training data (rare situations/events) to verify correct model operation.

In both cases above, the inference entity is given a pattern to look for in the input/output/side-information data (e.g., specific distribution of RSRP measurements in Set B for beam management or specific patterns in the CSI/PRS for positioning) and once these are detected, data have to be collected (either for training either for monitoring) including the GT label.

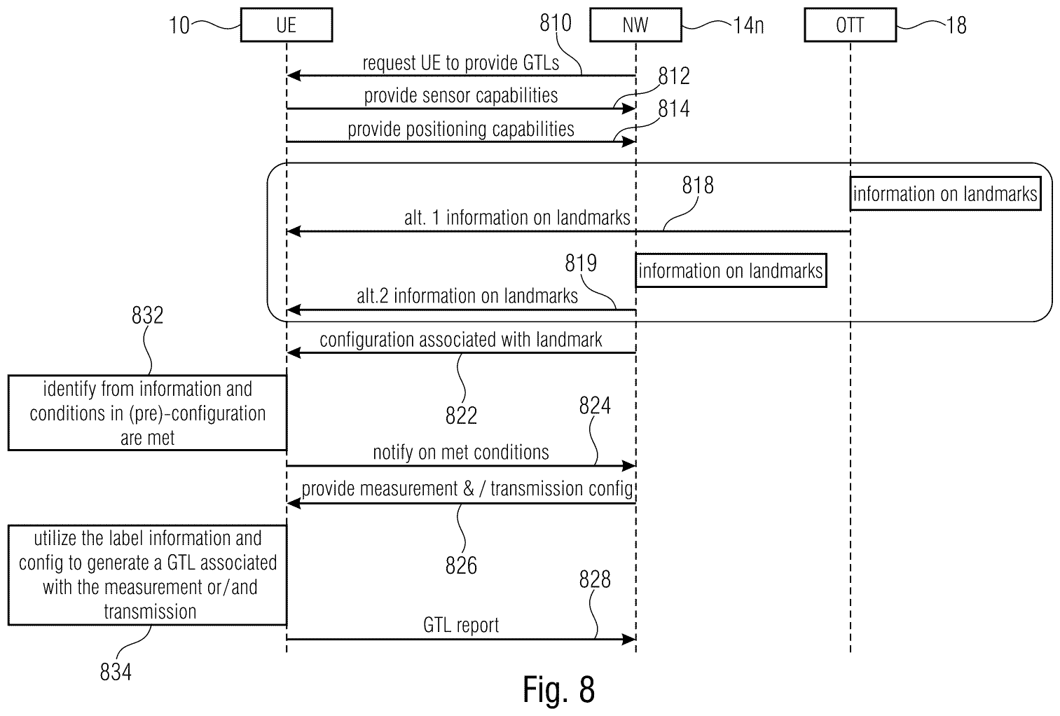

FIG. 8 illustrate entities functionality for utilizing the landmarks in the LCM incl. signaling and data flow.

In FIG. 8 the communication between UE 10, OTT 18 and the network 14n are shown. First a communication between network 14n and UE 10 is provided in the steps 810, 812 and 814. The steps comprise requesting UE to priority GTL in step 810, providing sensor capabilities in step 812 and providing position capabilities in step 814.

After that a communication between OTT 18 and network 14n and UE 10 is performed. The communication is marked by the steps 818 and 819. Here the information on landmarks are provided.

At the end of the illustrated methods the steps 822, 824, 826 and 828 are performed, where information between network 14n and UE 10 are exchanged in between, the UE 10 performs the steps 832 and 834. First the configuration associated with the landmark is provided in step 822, so that the UE 10 can identify, whether the conditions are met in step 832. After that a notification on the met conditions is provided in step 824 by UE 10. In response to this, the network 14n provides measurements/transmission configuration in step 826, so that the UE 10 can utilize the label information and configuration to generate a GTL associated with the measurement and/or transmission in step 834. At the end the GTL report is provided in 828 from the UE 10 to the network 14n.

Below an embodiment for determining whether a deployed model performs well in an applicable condition before it can be activated will be discussed. In order to verify the correct operation of a UE-side or two-sided ML model after identification but prior to its first active use, it may be needed to validate the model based on its performance and accuracy in detecting rare situations or events that do not frequently occur in the training data. To do this, the ML inference entity is given a pattern to look for in the input/output/side-information data (e.g., specific distribution of RSRP measurements in Set B for beam management or specific patterns in the CSI/PRS for positioning). Once it detects the pattern, data can be collected for either training or monitoring purposes, including the use of ground truth labels obtained through landmark detection. It is important to ensure that sufficient data coverage is obtained during validation to reliably validate the model.

To verify the correct operation of a UE-side or two-sided ML model the UE can collect data on and/or detect rare situations or events that do not frequently occur in the training data, and use landmark detection to obtain ground truth labels. Validating the model's performance based on these rare events can ensure its reliable operation.

### Using Internal Sensors and Landmarks (No Information or Only Part of the Information is Known or Provided to Network)

A UE is configured to respond with an action when one or more events associated with detection of the landmark is detected. The event may be detected by higher layers in a protocol stack, for example, the application layer.

When an application or software running in a higher layer detects an event, it triggers the lower layer to perform a certain action. As an example, a camera detects a QR code which the UE is configured to search for or respond. The QR code may contain information (for example, within the data stream) indicating the QR code indicates a landmark containing certain type of information, such as indicating that the QR contains a ground truth label. One example of such ground truth label could be location dependent information (e.g. coordinates) and/or orientation dependent information (e.g. Quaternions and/or roll, pitch, yaw with respect to certain reference frame and/or top/down). Furthermore, in the application layer, the UE may be able to obtain one or more information while processing the QR code, for example, the UE may be able to measure some ground truth information, such as the orientation of the UE with respect to the QR code, rough distance to the QR code, etc. . . . by utilizing one or more information contained within one or more of the finder pattern, separators, timing pattern, alignment patterns parts associated with the QR code.

Another example of ground truth label in the higher layer could be NFC (near field communication) NFC measurements. A UE may be configured to report a ground truth label, when the UE comes in contact with an NFC tag. Examples could be NFC tags in the access control systems. Such access control tags could be examples of external ground truth reference systems. Parameters from reading NFC tags could further used as additional information.

The information obtained by higher layer processing (e.g. at the application layer) may further be associated with one or more measurement performed by the UE on radio signals based on mobile communication standard (such as NR signals, LTE, WiFi, WiFi-6). Furthermore, information may be further associated with one or more further sensors available within the UE. The association may be based on time reference, wherein the time reference may be obtained from external reference (such as GNSS, from a network node, from a second UE) or from the UE itself. Such time reference associates the time the measurement is made using the landmark, to the measurement made from the application layer.

In a yet another example, the location dependent information may be encoded within a message transmitted by a network node (e.g. a TRP) or a second UE (e.g. using sidelink). The UE could be configured to report the ground truth based on proximity detection. For example, report when the RSRP is within a certain threshold. For example, the ground truth could be carried in a system information, such as positioning system information transmitted in one or more positioning system information blocks (posSibs). In an example, the system information containing the ground truth information transmitted by one or more TRP in response to a request by the UE.

Furthermore, the location dependent label obtained using a sensor of the UE (such as camera) may be combined with location dependent label obtained by obtaining information from the wireless system (e.g. by obtaining system information, ProSe messages, CAM message or other higher layer application messages), and may be associated with the measurement made on the physical layer of the radio interface (e.g. physical layer measurement made reference signals, such as downlink positioning reference signals, sidelink positioning reference signals, channel state information reference signals, demodulation reference signals, etc).

### Actions

The UE may be configured to report one or more of the information contained within the QR code and/or one or more information obtained while processing the QR code to the network. The UE may further report one or more measurement obtained from the measurement of the physical layer.

The UE may be configured by the network to use the information obtained from its higher layer in the protocol stack (e.g. application or system information), and use the truth label as a means to validate the performance of its AI/ML model used to predict the UE position and/or the beam information.

The UE may be configured by the network to use the information obtained from its higher layer in the protocol stack (e.g. application or system information), and use the truth label as a means to generate training data. The training data may be consumed by the UE for its training and/or it may be reported to the network entity and/or it may be reported to an entity outside the wireless communication network.

### Events

A UE may be configured to measure and/or perform certain actions based on events. The events may be
1) Based on detection of certain type of location dependent information (e.g. detection of QR code by a camera).
2) Based on measurement

How the information may be carried:
1) In LPP message
2) In measurement report
3) Using event exposure framework

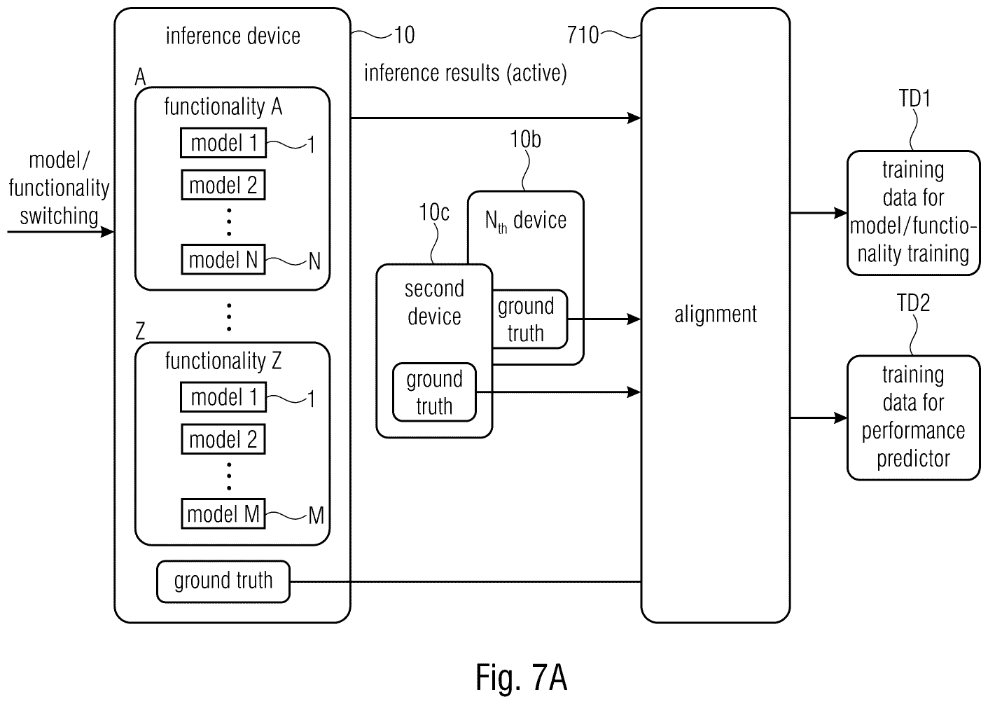

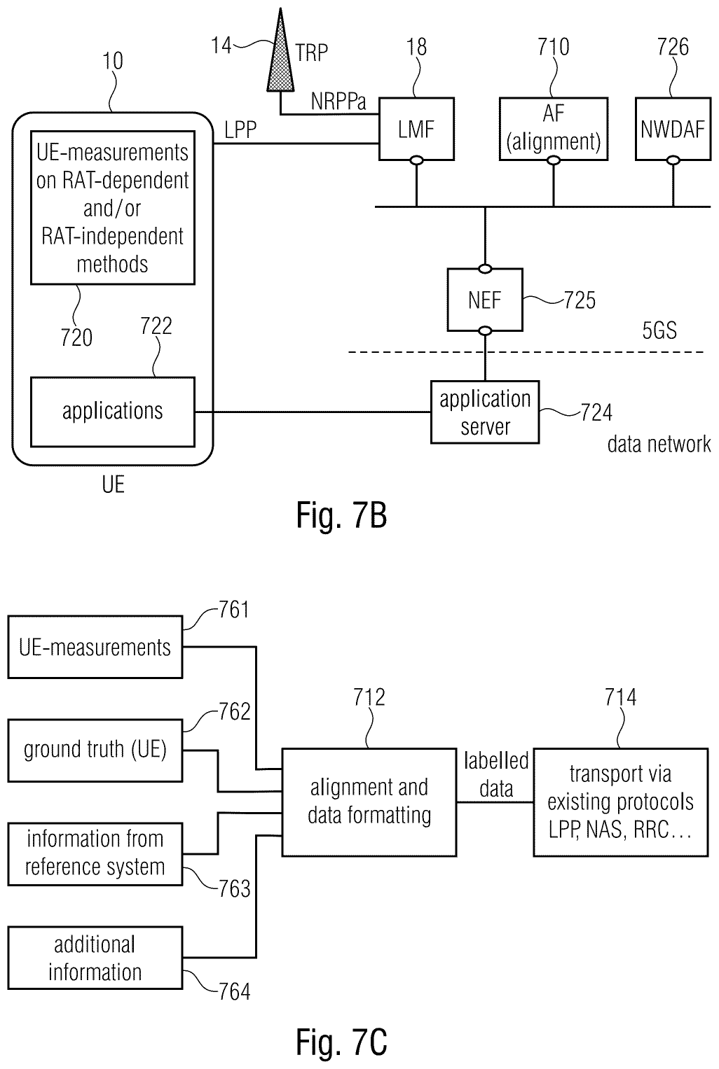

FIG. 7a-c illustrated an alignment of ground truth obtained by application layer processing (e.g. based on optical QR code, traffic signs or based on other reference systems) using application server located in data network.

FIG. 7a illustrates how the inference device 10 having models 1 to N and 1 to M for the different functionality 8 to Z together with an information on the grounded truth can use the models for generating training data as illustrated by TD1 and TD2. In the step of alignment 710 the inference results provided by 10 and further devices 10b and 10c are aligned so as to obtain the training data TD1 and TD2.

In one variant, the UE may be able to obtain landmark informations, such as QR code, using UE application layer software. The application may communicate with a server in the data network (e.g. the server of the vendor who may be training the machine learning model, server within the trusted domain of the 5GS . . . etc). The landmark information may be associated with an identifier, such as timestamp which allow two landmarks to be associated to one other in terms of logical relation. For example, the two landmarks may be QR code scanned with an interval of 5 ms between them. Alternatively, the identifier may be used by a network entity later to associate the application layer information obtained from the application layer server with the information obtained from within the 5GS. In this example illustrated by FIG. 7b, the UE 10 may report one or more measurement from one or more RAT-dependent or RAT-independent system (cf. 720) and report them to the LMF 18 using LPP protocol (lpp). Likewise, the TRP 14 may report the measurement of signals emitted by the UE 10 and report it to LMF 18 using the LPP protocol LPP.

The application function 720 may have (for example) subscribed to an AF (e.g. the LMF 18) and a second AF (e.g. the application server) and may align these information in step or entity 710. The application server 724 may be within the trusted domain of the 5GS, in which case the AF could interact directly otherwise the application server 724 may interact with network function using the network exposure function (NEF). The aligned information may be provided to network data analytics function, which may use the information to train the model and/or monitor the model and/or provide correction data to another entity (LMF 18 or UE 10).

In a second variant (embodiment), the UE may be able to align the information available at the UE side. The information from the application layer, where one or more information may have been produced by one or more applications running on the UE. There may be optional extraction of information from the different applications 722 and alignment 710 and further processing of such information. The outcome of such processing and/or alignment and/or formatting are termed labels and these are transported to the network via one of the existing protocols between the network and the UE.

In yet another variant (embodiment), the UE 10 may expose its measurement from the lower layers (e.g. physical layer) and may make such information available to the application layer software. The application layer software combine the information obtained from the lower layer with the information available at the application (and/or other applications running on the same UE 10) and process the information and/or send to a external server (e.g. in the data network) for processing. The application server may utilize such model for training existing models, monitoring the performance of the model or any one of the LCM steps with AI/ML model described in this document. Alternatively, the application server may retrieve certain information from the network using the NEF 725. Alternatively, the server may provide the data to NWDAF 726 or a second application function, which performs alignment of data and provide further to NWDAF 726 for further analysis (e.g. training ML model, validation, monitoring . . . etc).

In FIG. 7c the alignment for obtaining labelled data is illustrated. The method starts with the four steps 761, 762, 763 and 764 which may be all performed or just a selection of same performed. The output of the 124 steps 761 to 764 is provided to the alignment and data formatting 712. The output of the step 712 are labelled data set which can then be transported via existing protocols like LPP, NAS, RRC in the step 714.

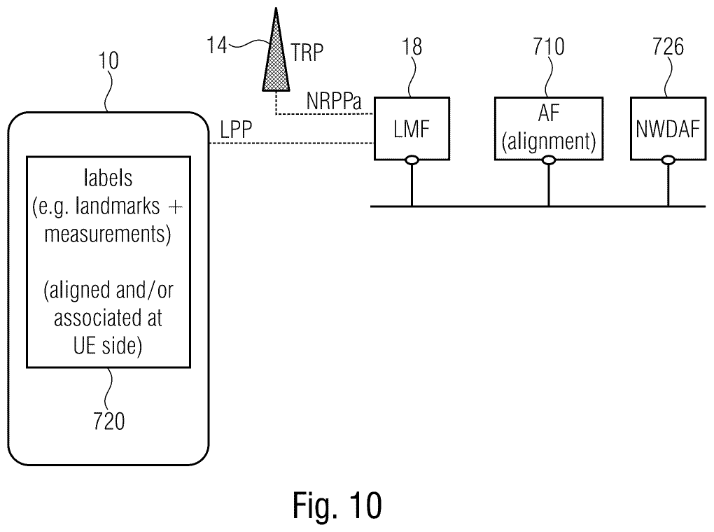

The AI/ML model may be trained at the core network (for example, in the NWDAF 726 or another application function, cf. FIG. 10) and stored at the core network at an entity or application function, such as the UDR). The embodiment of FIG. 10 is comparable to the embodiment of FIG. 7, but reduced with respect to the entities in charge. Here just the UE communicates via the transmission point 14 to the network entities LMF 18, AF 710 and NWDF 726.

Alternatively, the model may be trained at an entity outside the core network, for example, at a computing system outside the 5G core network and delivered to the 5G core network. One way to do so would be that an application function in the 5G core network allows the external entity which has a trained model stored in it to publish to the application function inside the core network using for example the NEF 725 interface. Alternatively, the AF inside the CN may subscribe to the entity outside the core network (for example a server in the data network) and obtain the model by interacting with the server in the data network. As a further alternative, the model can be transferred using operation and maintenance interfaces.

A network function may interact with the UDM or a second network function to determine the authorization and/or subscription to request certain data from the UE and/or to provide data collected from the UE to a third network function or a client or server. For example, the UE may have privacy profiles stored at the UE, or one or more network entities may have stored privacy profiles and/or authorization stored. The information may be provided to entities outside the 5G core network and/or outside the network function that has obtained the information, subject to authorization to do so. As an example, the measurement obtained by a network entity associated with a transmission from a UE and/or the measurement or information reported by a UE may be transferred to an external client (e.g. a server in the data network) subject to authorization. For example, if the UE has denied the location related information being shared to an external client, then the external client cannot obtain the training data from the said UE. The privacy profile may be stored in an AF (such as AMF or UDM or UDR or AUSF).

The delivery of model is subject to subscription and/or authorization to the UE.

Additional embodiments will be discussed below:

An embodiments refers to Landmark Data collection devices (refinement based on 3GPP progress):

The system includes a user equipment (UE), which can for example consist of both RUs (Reference UEs) and non-RU UEs. RUs are reference devices that are identified and designated by the network to have specific capabilities, such as assisted label generation for positioning or communication usages. These RUs are for example capable of generating landmark information associated with specific operations. On the other hand, non-RU UEs are normal devices that may not have the same designated capabilities as RUs. However, they are still capable of providing reference information that can contribute to the process or LCM stages (monitoring, training, validation, calibration).

RUs (Reference UEs) are designated reference devices with capabilities for LCM assistance such as label generation. The main differentiating factor between RUs and non-RU UEs is the confidence in the reported landmark information. This confidence arises from the fact that the network considers RUs as complementary sources of quality reports. Examples include PRUs (Positioning Reference UEs), Anchor UEs, temporally Reference UEs which are acknowledged by the network to be temporarily used as RUs.

Non-RU UEs, while lacking the specialized capabilities of RUs, still contribute valuable reference information. Examples include: Regular UEs, IoT Devices.

An embodiments refers to Scenario Base station generate measurements and UE generate Landmark:

When measurements are made by a second device (e.g., TRP, gNB, or another UE in sidelink operation) and the UE acts as a provider of landmark information. The UE can according to embodiments report the landmark information along with a timestamp. Additionally, the UE may be triggered or configured to uplink (or sidelink) transmit specific signal(s), resource(s), or resource set(s) to enable measurements to be made by the second device. By associating the landmark information with the transmitted signal(s), resource(s), or resource set(s), the gNB or a core or server can utilize the landmark information and measurements from the second device to establish the training data. Importantly, the landmark location can be determined in a transparent manner for the TRP/gNB to ensure that the UE's privacy and location are not derived at the RAN network. The timestamps associated with the landmarks and the TRPs/gNBs can according to embodiments be utilized to synchronize and correlate the data for training purposes.

Expressed in other words, this means, that according to an embodiment the base station is interpreted as second device generating or performing the measurement, wherein the UE generates the landmark. Optional features like the timestamp may be used as well.

In one embodiment, the present invention provides a system for landmark-assisted label generation in wireless networks. The system comprises several components that work together to facilitate the accurate labeling of specific measurement or transmission operations, comprising:
A UE configured to generate landmark information associated with a specific measurement or transmission.
A measurement device being configured to generate measurements for the UE transmission.
A processing entity, such as a core network or server, configured to receive the landmark information and measurements, and generate a label associated with the specific operation based on the combined information.

In one embodiment, the present invention provides a method for landmark-assisted label generation in 5G networks, comprising:
Generating landmark information by a UE associated with a specific measurement or transmission operation.
Generating measurements for the specific operation by a second device
Receiving the landmark information and measurements at a processing entity, such as a core network or server.
Associating the landmark information and measurements with the specific operation to generate a label for the operation.

An embodiments refers to Beam Management Optimization using Landmark Information In one embodiment, the present invention provides a method for beam management optimization in a UE using information received from the network, without sharing UE position information, comprising:
1. Receiving information from the network regarding a landmark associated with at least one downlink or uplink resource or measurement.
2. Utilizing the received information in the beam management process to optimize beam configuration and selection.
3. Enhancing the beam management and communication performance based on the association between the landmark and the received information.

Embodiments use for example Landmark Beam Information: The UE receives landmark information from the network indicating the one or more resources or measurement configuration associated with the landmark. The information can be associated with a narrow set of beam selection from a wider set.

Embodiments use for example Preferred Beam Selection: the network can suggest a list pf preferred beans associated with a landmark. The UE incorporates the suggested preferred beam into its beam configuration based on the landmark information.

Embodiments use for example Non-Preferred Beam Avoidance: Conversely, the network can suggest a list pf preferred beans associated with a landmark. The UE incorporates the suggested preferred beam into its beam configuration based on the landmark information. The UE adjusts its beam selection to avoid the non-preferred beams indicated by the network.

Embodiments use for example Tracking Between Landmarks: The UE receive information on beam profiles between multiple landmarks. This can be extremely helpful to avoid unnecessary handover and enhance user mobility. UE tracks its movement between landmarks using the associated beams. As the UE moves between landmarks, it dynamically adjusts the beam configuration based on the associated landmark information.

Below, methods of training data collection, monitoring, validation/model calibration according to different embodiments will be discussed:

LCM phases may for example be:
training
testing/validation
inference
monitoring and model/functionality management

Landmarks for training may for example be:
data collection, ground truth measurements, triggered measurements, etc.—this is extensively covered in the application

Landmarks for testing/validation may for example be:
When a model is new (tested under RAN4 but not yet deployed in many areas in the “real” world), it makes sense to evaluate its performance before first activation in new areas/environments.
The trained model can be at the NW, UE or anywhere else. Once information (measurements, labels, etc.) from a landmark can be acquired, the performance of the inactive model can be validated (in parallel to the active model).
In other words, even though the active model might not need monitoring, landmarks are used for the performance testing/validation of inactive models.

Landmarks for inference may for example be:
Landmarks for inference in BM are explained in the new paragraph above
Landmarks for inference for positioning are also self-explanatory: if I can use a landmark to monitoring the performance of an AI/ML model, I can also use a landmark to get a good estimate of the actual UE position (e.g., barcodes in an airport or a warehouse)
Landmarks for HO management assistance?

Landmarks for model/functionality performance monitoring may for example be:
For model, explained in detail in the above description note the functionality for monitoring can be basically the same, as already defined in the TR.
Landmarks can also help with reducing the complexity of monitoring: it is less burden in many cases to utilize a landmark than for example doing a full beam sweep or get a ground truth position with other means.

Landmarks for model/functionality management may for example be:
As defined in the application, landmarks can assist understanding if an environment changed.
   This can determine if a model needs to be trained or adapted or not
   This can determine if a functionality can still perform in a specific setting/scenario/area
Information on the existence of landmarks available for monitoring in an area might affect if a functionality/model is selected to be applied in that area (e.g., maybe the NW does not activate a functionality when the UE-side or NW-side model cannot be efficiently monitored)

Below the signaling according to embodiments will be discussed.

A UE may according to embodiments be static or moving UE. For example, a static UE may be deployed by the network operator for monitoring purposes, as a positioning reference unit. Such UE may perform positioning measurements, such as RSTD, RSRP, UE Rx-Tx Time Difference, DL-RSCPD, DL-RSCP etc.) and report the measurement to the location server. Furthermore, the UE may also transmit uplink reference signals, enabling the network nodes to measure and/or calibrate the uplink measurements (such as RTOA, UL-AoA, gNB Rx-Tx-Time difference, UL-RSCP). Such UE may also further provide the known location of the UE to the location server. Alternatively, the location server may be able to obtain the location information of the UE from a database stored at the network (e.g. UDM, O&M database etc). The static UE could be deployed with a very accurate knowledge of location dependent parameters, such as location and/or orientation.

The following diagram provides an example of signalling mechanism from UE perspective for providing ground truth label, as a part of the positioning procedure.

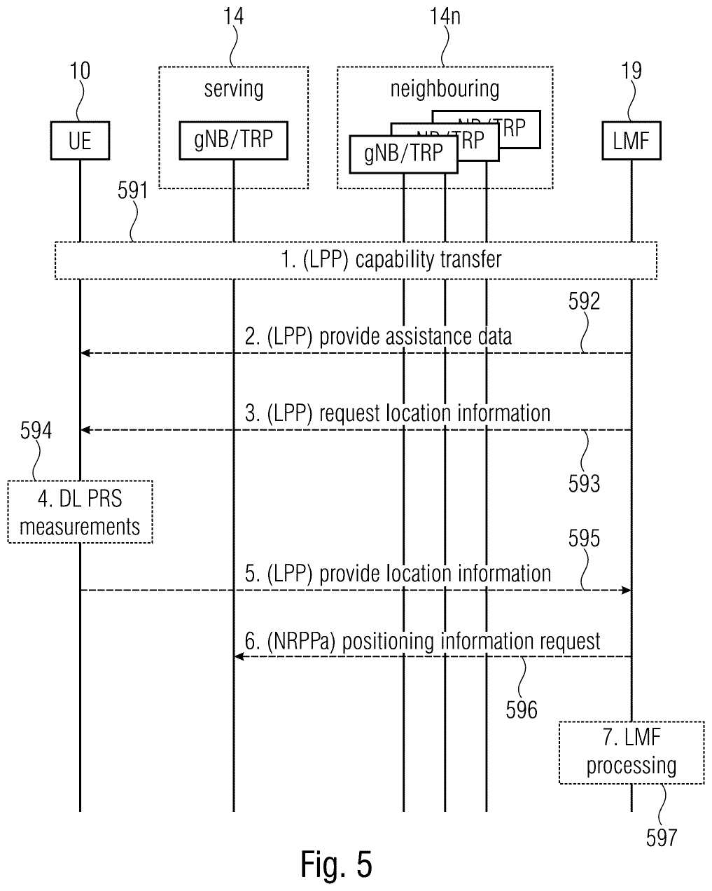

As illustrated by FIG. 5 the UE 10 communicates with the LMF 19 as a network entity and the serving transmission point 14. Furthermore, neighboring transmission points 14n may be present. In the first step the UE 10, the serving transmission point 14, the neighboring transmission point 14n and the LMF perform the step of capability transfer as illustrated by the step 591. The capability transfer may be done proactively by the UE 10 or in response to a capability query via the network 14, 14n, and 19 as will be discussed in detail below.

After that, the LMF 19 provides assistance data in the step 592 and can request location information in the step 593. The UE 10 may then perform a measurement in the step 594 and provides the respective location information in the step 595.

According to an embodiment a position information request from the LMF 19 to the serving transmission points 14 or the other neighboring transmission points 14n may follow as illustrated by step 596. Based on this information the LMF can perform its processing as illustrated by the step 597.

In step 591 capability transfer may be transferred either proactively by the UE (using message ProvideCapabilities) or in response to the capability query by the network (e.g. using ProvideCapabilities message RequestCapabilities). The ProvideCapabilities may provide the UE capabilities for each positioning method, for which the capability is requested by the server in RequestCapabilities message. Likewise, the UE may also indicate proactively the capabilities corresponding to at least one positioning method that the UE supports and would like to indicate to the network.

Furthermore, the UE may according to embodiments also indicate its capabilities to act as a PRU, or act as a PRU in a temporal sense. Furthermore, the UE may also indicate its capabilities to provide landmark related information, such as scanning QR code, optical-based positioning, camera-based landmark recognition, etc.

An example of the message ProvideCapabilities could look like:

-- ASN1START
ProvideCapabilities ::= SEQUENCE {

| | |
|---|---|
| criticalExtensions | CHOICE { |
| c1 | CHOICE { |
| provideCapabilities-r9 | ProvideCapabilities-r9-IEs, |

```
      spare3 NULL, spare2 NULL, spare1 NULL
    },
```

| | |
|---|---|
| criticalExtensionsFuture | SEQUENCE { } |

}
}
ProvideCapabilities-r9-Ies ::= SEQUENCE {

| | | |
|---|---|---|
| commonIEsProvideCapabilities | CommonIEsProvideCapabilities | OPTIONAL, |
| a-gnss-ProvideCapabilities | A-GNSS-ProvideCapabilities | OPTIONAL, |
| otdoa-ProvideCapabilities | OTDOA-ProvideCapabilities | OPTIONAL, |
| ecid-ProvideCapabilities | ECID-ProvideCapabilities | OPTIONAL, |
| epdu-ProvideCapabilities | EPDU-Sequence | OPTIONAL, |

...,

| | | | |
|---|---|---|---|
| [[ | sensor-ProvideCapabilities-r13 | Sensor-ProvideCapabilities-r13 | OPTIONAL, |
| | tbs-ProvideCapabilities-r13 | TBS-ProvideCapabilities-r13 | OPTIONAL, |
| | wlan-ProvideCapabilities-r13 | WLAN-ProvideCapabilities-r13 | OPTIONAL, |
| | bt-ProvideCapabilities-r13 | BT-ProvideCapabilities-r13 | OPTIONAL |

]],

| [[ | nr-ECID-ProvideCapabilities-r16 | NR-ECID-ProvideCapabilities-r16 | OPTIONAL, |
|---|---|---|---|
| | nr-Multi-RTT-ProvideCapabilities-r16 | | |
| | | NR-Multi-RTT-ProvideCapabilities-r16 | OPTIONAL, |
| | nr-DL-AoD-ProvideCapabilities-r16 | | |
| | | NR-DL-AoD-ProvideCapabilities-r16 | OPTIONAL, |
| | nr-DL-TDOA-ProvideCapabilities-r16 | | |
| | | NR-DL-TDOA-ProvideCapabilities-r16 | OPTIONAL, |
| | nr-UL-ProvideCapabilities-r16 | NR-UL-ProvideCapabilities-r16 | OPTIONAL |

]]

| | | | |
|---|---|---|---|
| [[ | gtl-ProvideCapabilities-r19 | GTL-ProvideCapabilities-r19 | OPTIONAL |

]]
}
-- ASN1STOP

GTL-ProvideCapabilities-r19 could indicate, the UE to provide the ground truth label and what type of ground truth label it could provide.

-- ASN1START
GTL-ProvideCapabilities-r19 ::= SEQUENCE {

| supportedGTLTypes-r19 | BIT STRING { | UE-based-Position |
|---|---|---|
| | | (0), QR-code (1), |
| | | VisualLandmark(2)} |
| | | (SIZE (1..8)), |
| supportedGTLDeviceType-r19 | BIT STRING { | PRU (0) |

temporalPRU(1) }
(SIZE (1..8)),

}
-- ASN1STOP

Based on the capabilities, the location server may according to embodiments configure to position the UE using certain positioning method. The location server may provide assistance data (cf. 592), using the ProvideAssistanceData message to the UE to enable measurements using certain downlink positioning reference signals or to enable UE-based positioning using RAT-independent technology (such as GNSS) or enable the UE to report certain measurement (e.g. using Bluetooth). In the context of obtaining ground truth label, the ProvideAssistanceData message 592 may contain further information about the expected landmark around the UE.

-- ASN1START
ProvideAssistanceData ::= SEQUENCE {

| | |
|---|---|
| criticalExtensions | CHOICE { |
| c1 | CHOICE { |
| provideAssistanceData-r9 | ProvideAssistanceData-r9-IEs, |

```
      spare3 NULL, spare2 NULL, spare1 NULL
    },
```

| | |
|---|---|
| criticalExtensionsFuture | SEQUENCE { } |

}
}
ProvideAssistanceData-r9-IEs ::= SEQUENCE {

| | | |
|---|---|---|
| commonIEsProvideAssistanceData | CommonIEsProvideAssistanceData | OPTIONAL, -- |

Need ON
... .
[[

| | | |
|---|---|---|
| gtl-ProvideAssistanceData-r19 | GTL-ProvideAssistanceData-r19 | OPTIONAL -- |

Need ON
]]
}
-- ASN1STOP

The type of assistance data sent by the server may according to embodiments be in response to the assistance data type that is requested by the UE, or sent proactively by the network taking into account the supported capabilities of the UE (as indicated by the UE in the ProvideCapabilities 591).

-- ASN1START
GTL-ProvideAssistanceData-r19 ::= SEQUENCE {

| | |
|---|---|
| landmarkLocation | LocationCoordinates OPTIONAL |

landmarkLocationAccuracy INTEGER (0..50000) OPTIONAL

| | | |
|---|---|---|
| landmarkType | BIT STRING { | UE-based-Position (0), |

QR-code (1),
VisualLandmark(2)}
(SIZE (1..8)),

}
-- ASN1STOP

Below the usage of the landmarks for the position, determination are discussed in detail:

The example above shows one possible mechanism of indicating the landmark information to the UE to enable the UE to search for a landmark in a given area and report the landmark. In general, the ProvideAssistanceData may provide different type of information that are useful for the UE to find the ground truth, and report them to the network in next step.

The network may have information regarding the landmark. For example, the network may know the location of the landmark. The information about the landmark may be provided to the UE by associating it with an identifier. The landmark information may be associated with a validity criteria. For example, the UE may search for a certain landmark only when the UE is at a certain location. For example, for a given area, the UE may be provided with a list of landmarks to search for. The area may be a certain GAD shape (e.g. a circle, ellipsoid) around a certain point whose coordinates are provided. For example, a UE that computes its location 5 m around a configured point, may search for one or more landmarks the UE is configured to search for. This information may be provided as a preconfiguration, as system information or as assistance data.

In one example, the information provided as an assistance data may be used by the UE to detect the indicated landmark and provide report. In another example, the UE may be configured a list of landmarks to search for based on the validity area of the list and/or each individual elements in the list. Such configuration applicable to a broader area (e.g. within a cell, within a group of cells, etc) may be stored by the UE and searched for when the UE enters the applicable area. Furthermore, there may be generic landmarks the UE may be configured to search for. For example, generic signs (such as traffic signs), which may occur often.

There may according to embodiments be additional AI/ML models that are deployed to detect and process the generic landmarks, which may be activated based on their location. In addition, the list of generic landmarks may also be provided over the top, wherein the UE receives a trigger to activate the processing on generic landmarks.

The RequestLocationInformation message (step 593) is according to embodiments used by the location server 19 to request the UE 10 to report the location measurements (step 595) indicated by the UE. The message indicates what information the server expects from a UE for a given positioning method. For example, in case of DL-TDOA, it may indicate whether the server is requesting reporting additional path (multipath components) in addition to the RSTD measurement. In this example, the RequestLocationInformation may request the information to provide certain information from the ground truth label. The location server, may for example, request the orientation of the UE when a GTL was detected, the information read from the GTL, etc. The location server may indicate it expects the GTL together with measurement (i.e. the measurement corresponding to the time the GTL was taken).

In one example, the ProvideAssistanceData message may be sent in response to the RequestAssistanceData from the UE. In response to some higher layer event (e.g. the user activating location request (e.g. map application) with a landmark search (e.g. the objects around the user), the UE may request the location server to provide one or more landmarks to the UE. The UE request may further include the type of landmark assistance it is requesting. The location server may provide a list of landmarks, and/or additional assistance (e.g. ML model and/or an identifier to the to the ML model). The provided information may be associated with a validity time and/or validity area. The UE may store the landmark information for the duration indicated in the validity time and/or as long as the UE dwells within validity area. A validity area may be a portion of the cell indicated using a GAD shape (e.g. a circle or ellipsoid around a certain point), or cells, portion of cell, combination of cells.

Likewise, the UE 10 may according to embodiments request on-demand system information to request assistance data from the server as SI message or posSib messages, to acquire information about the landmarks within a broader area and/or applicable to several UEs.

-- ASN1START
RequestLocationInformation ::= SEQUENCE {

| | |
|---|---|
| criticalExtensions | CHOICE { |
| c1 | CHOICE { |
| requestLocationInformation-r9 | RequestLocationInformation-r9-IEs, |

```
      spare3 NULL, spare2 NULL, spare1 NULL
    },
```

| | |
|---|---|
| criticalExtensionsFuture | SEQUENCE { } |

```
  }
}
RequestLocationInformation-r9-IEs ::= SEQUENCE {
  commonIEsRequestLocationInformation
```

CommonIEsRequestLocationInformation OPTIONAL, --

...
[[

| | |
|---|---|
| gtl-RequestLocationInformation-r19 | GTL-RequestLocationInformation-r19 |

```
  OPTIONAL -- Need ON
  ]]
}
-- ASN1STOP
```

Alternatively, within each positioning method, a request may be made that the measurements are to be transmitted with the ground truth label.

The ProvideLocationInformation message body in a LPP message may be used by a UE to provide positioning measurements or position estimates to the location server. Furthermore, the UE may provide the requested ground truth label with the message.

-- ASN1START
ProvideLocationInformation ::= SEQUENCE {

| | |
|---|---|
| criticalExtensions | CHOICE { |
| c1 | CHOICE { |
| provideLocationInformation-r9 | ProvideLocationInformation-r9-IEs, |

```
      spare3 NULL, spare2 NULL, spare1 NULL
    },
```

| | |
|---|---|
| criticalExtensionsFuture | SEQUENCE { } |

```
  }
}
ProvideLocationInformation-r9-IEs ::= SEQUENCE {
  commonIEsProvideLocationInformation
```

CommonIEsProvideLocationInformation OPTIONAL,

```
  ... . .
  [[
```

| | |
|---|---|
| gtl-ProvideLocationInformation-r19 | GTL-ProvideLocationInformation-r19 |

```
  OPTIONAL -- Need ON
  ]]
}
-- ASN1STOP
```

A UE may according to embodiments be configured to provide ground truth label and measurement using the same positioning method as it is used for computing the location of the UE. Alternatively or in addition, the UE may be configured to provide ground truth from an independent source (for example, from higher layer processing). In this situation, the IE GTL-ProvideLocationInformation-r19 contains the information pertaining to the ground truth label. For example, the GTL-ProvideLocationInformation IE may contain information about the UE orientation when the reported measurement was made. Assuming that the GTL was obtained by scanning the QR code, this IE could contain information read from the QR code, together with other meta information about the relationship between the landmark (e.g. the QR code) and the UE. In general, the ProvideLocationInformation may transfer the information about the landmark and its relation to the UE. For example, the orientation and/or estimated range to the UE (estimated by for example optical means).

The detected landmark information can according to embodiments be indicated to the location server by associating it with the identifier provided by the location server or network entity, associated with the landmark. This identifier may be provided, for example, in the ProvideAssistanceData, SI message, RRC Message, or posSib message. The UE could provide relative information to the landmark. The identifier may consist of several bits, by which the location server is able to associate it with the landmark information it holds or it has provided previously to be UE.

In other example, a UE may provide the ground truth label in response to a trigger. The trigger could come from the UE's higher layers. For example, if a user opens an application (e.g. a navigation application) and performs certain configured operation (e.g. start scanning nearby objects), this could trigger the lower layers to perform measurement. The UE could then provide the ground truth labels to the network, together with the measurements.

A UE could according to embodiments report its orientation (e.g. using Quaternions) and its known location (e.g. computed by RAT-dependent means) and/or measurement (e.g. of one or more DL-PRS configurations such as RSTD, AoD . . . etc) and/or timestamp.

Likewise, the higher layer (e.g. UE applications) interactions could—according to embodiments—trigger the UE to transmit certain reference signal. For example, the UE may be configured to transmission of uplink sounding reference signal in response to an event. For example, initiating a certain action on an app could send trigger to the lower layers to initiate the sounding reference signal transmission. The event may generate ground truth information for the UE. The UE then provides the ground truth label associated with the uplink sounding reference signal. As an example, the UE could provide the timestamp of SRS transmission and provide the ground truth label at the said timestamp.

For example, the LMF may utilize the received ground truth label from one or more UEs for training and/or monitoring of AI/ML models or performance of the UE or integrity operation.

All embodiments described above are applicable for different mobile networks LCM cases such as mobility, communication, handover, and power management: These LCM cases can utilize landmarks.

Although some aspects of the described concept have been described in the context of an apparatus, it is clear that these aspects also represent a description of the corresponding method, where a block or a device corresponds to a method step or a feature of a method step. Analogously, aspects described in the context of a method step also represent a description of a corresponding block or item or feature of a corresponding apparatus.

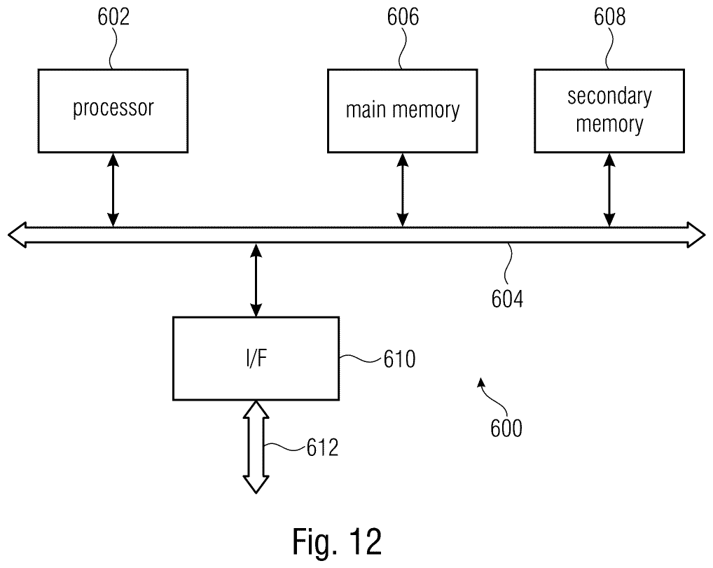

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 12 illustrates an example of a computer system 600. The units or modules as well as the steps of the methods performed by these units may execute on one or more computer systems 600. The computer system 600 includes one or more processors 602, like a special purpose or a general-purpose digital signal processor. The processor 602 is connected to a communication infrastructure 604, like a bus or a network. The computer system 600 includes a main memory 606, e.g., a random-access memory, RAM, and a secondary memory 608, e.g., a hard disk drive and/or a removable storage drive. The secondary memory 608 may allow computer programs or other instructions to be loaded into the computer system 600. The computer system 600 may further include a communications interface 610 to allow software and data to be transferred between computer system 600 and external devices. The communication may be in the from electronic, electromagnetic, optical, or other signals capable of being handled by a communications interface. The communication may use a wire or a cable, fiber optics, a phone line, a cellular phone link, an RF link and other communications channels 612.

The terms “computer program medium” and “computer readable medium” are used to generally refer to tangible storage media such as removable storage units or a hard disk installed in a hard disk drive. These computer program products are means for providing software to the computer system 600. The computer programs, also referred to as computer control logic, are stored in main memory 606 and/or secondary memory 608. Computer programs may also be received via the communications interface 610. The computer program, when executed, enables the computer system 600 to implement the present invention. In particular, the computer program, when executed, enables processor 602 to implement the processes of the present invention, such as any of the methods described herein. Accordingly, such a computer program may represent a controller of the computer system 600. Where the disclosure is implemented using software, the software may be stored in a computer program product and loaded into computer system 600 using a removable storage drive, an interface, like communications interface 610.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate or are capable of cooperating with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier. In other words, an embodiment of the inventive method is, therefore, a computer program having a program code for performing one of the methods described herein, when the computer program runs on a computer.

A further embodiment of the inventive methods is, therefore, a data carrier or a digital storage medium, or a computer-readable medium comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device, for example a field programmable gate array, may be used to perform some or all of the functionalities of the methods described herein. In some embodiments, a field programmable gate array may cooperate with a microprocessor in order to perform one of the methods described herein. Generally, the methods are performed by any hardware apparatus.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

### Abbreviations

| Abbreviation | Definition |
|---|---|
| 3GPP | third generation partnership project |
| 5GC | 5G core network |
| BS | base station |
| CSI-RS | channel state information reference signal |
| DMRS | demodulation reference signal |
| DOA | direction of arrival |
| E-CID | enhanced cell ID |
| eNB | evolved node b |
| E-SMLC | evolved serving mobile location center. |
| E-UTRA | evolved UMTS terrestrial radio access |
| gNB | next generation node-b |
| GPS | Global Positioning System |
| LMF | location management function |
| LMU | location measurement unit |
| LPP | LTE positioning protocol |
| LTE | Long-term evolution |
| NG | next generation |
| ng-eNB | next generation eNB |
| NG-RAN | either a gNB or an ng-eNB |
| NR | new radio |
| NRPPa | new radio positioning protocol a |
| OTDOA | observe time difference of arrival |
| PRS | positioning reference signal |
| PTRS | phase tracking reference signal |
| QCL | quasi colocation |
| RAN | radio access network |
| RP | reception point |
| RSTD | reference signal time difference |
| RTOA | relative time of arrival |
| RTT | round trip time |
| SA | Standalone |
| SRS | sounding reference signal |
| TDM | Time Domain Multiplexing |
| TOF | time of flight |
| TRP | transmission reception point |
| RS | reference signal |
| QCL | quasi co-located |
| AoA | Angle of Arrival |
| AoD | Angle of Departure |
| PAS | Power Angular Spectrum |
| NR | New Radio |
| gNB | next generation node-b |
| GPS | Global Positioning System |
| LMF | location management function |
| LMU | location measurement unit |
| LPP | LTE positioning protocol |
| LTE | Long-term evolution |
| NG | next generation |
| ng-eNB | next generation eNB |
| NG-RAN | either a gNB or an ng-eNB |
| NR | new radio |
| CA | carrier aggregation |
| CAM | Cooperative Awareness Message |
| DAS | distributed antenna systems |
| DL | Downlink |
| FL | Frequency layer |
| FC | Frequency component. This is either a |
| | BWP of a wideband carrier or |
| GNSS | Global navigation satellite system |
| OOC | Out-Of-Coverage |
| PSFCH | Physical Sidelink Feedback Channel |
| P-UE | Pedestrian UE: should not be limited to |
| | pedestrians, but represents any UE |
| RS | Reference signal |
| RE | resource elements |
| SINR | Signal to interference and noise ratio |
| SL | Sidelink |
| SPRS, SP- | Sidelink positioning reference signals |
| V2X | Vehicle to anything |
| VRU | Vulnerable road user |
| V-UE | Vehicular UE |
| BWP | Bandwidth Part |
| TEG | Timing Error Group |
| ZC | Zadoff-Chu sequence |
| UE | User equipment |
| UL | Uplink |
| Uu (interface) | Interface between UE |
| ToA | Time of Arrival |
| TDOA | Time Difference of Arrival |
| LOS | Line of sight |
| PRU | Positioning reference unit |
| ToF | Time of flight |

1. User equipment (UE) comprising a transceiver for exchanging data supporting life cycle management (LCM) of machine learning model (ML model) and being configured to identify one or more landmarks to acquire one or more parameters on the one or more landmarks;
wherein identifying comprises determining the one or more parameters on the one or more landmarks based on the data supporting the life cycle management (LCM), the one or more parameters describe at least a presence of the one or more landmarks;
wherein the one or more parameters or an information derived from the one or more parameters is transmitted by the transceiver as part of exchanging data or wherein based on the one or more parameters an information is derived and/or a trigger is acquired or an utilizing the one or more landmarks is performed.

2. User equipment (UE) for supporting life cycle management (LCM) of machine learning model (ML model) and being configured to identify one or more landmarks to acquire one or more parameters on the one or more landmarks;
wherein the user equipment (UE) comprises a configuration (or pre-configuration), the configuration indicating information on the one or more landmarks or criteria to identify the one or more landmarks;
wherein identifying the one or more landmarks is based on information comprised by the configuration;
wherein identifying comprises determining the one or more parameters on the one or more landmarks, the one or more parameters describe at least a presence of the one or more landmarks;
wherein based on the one or more parameters an information is derived and/or a trigger is acquired or wherein the one or more parameters or an utilizing the one or more landmarks is performed or an information derived from the one or more parameters is transmitted by the transceiver.

3. User equipment according to claim 1, wherein exchanging data comprises receiving a configuration (or pre-configuration) from one or more network entities (NW, RAN, OTT, server), the configuration indicating information on the one or more landmarks or criteria to identify the one or more landmarks;
wherein identifying the one or more landmarks is based on information comprised by the configuration.

4. User equipment according to claim 1, wherein the information derived comprise an information on validation or test result.

5. User equipment according to claim 1, wherein the transmitted information comprises a report.

6. User equipment according to claim 1, wherein identifying is initiated by a user command; or
wherein identifying is triggered by the network to search for the one or more landmarks or wherein the transceiver receives information regarding conditions when a UE shall perform an action on the one or more landmarks.

7. User equipment according to claim 1, wherein the transceiver is configured to transmit information on capability and/or to receive configuration information or assistance data supporting the detection of the one or more landmarks.

8. User equipment according to claim 1, wherein the transceiver receives a request from the network information on a detected landmark and/or a request (RequestLocationInformation message) on performing a measurement and/or wherein the user equipment is configured to perform a measurement (on request) and to provide Position information for the network entity (LMF) and/or to provide assistance data message or to provide assistance data message in response to a request assistance data message (including or excluding type of landmark assistance)

9. User equipment according to claim 1, wherein the UE reports the measurements performed on the positioning reference signals together with the position derived from the landmark, or the relative position to the landmark to the network.

10. User equipment according to claim 1, wherein the one or more parameters comprise additionally at least one of:
position of the UE or the identified one or more landmarks;
information acquired from or associated with the one or more landmarks;
relative position to the one or more identified landmarks;
distance to the one or more identified landmarks;
direction with respect to the one or more identified landmarks;
angular information of the user equipment;
identifier derived from the landmark;
additional sensor data acquired using a sensor of the UE during identifying;
additional RF data received during identifying using the transceiver; and/or
wherein the one or more parameters comprise parameters to be used as ground truth label.

11. User equipment according to claim 1, wherein the UE is configured to determine a relative positioning to one or more identified landmarks in addition to the position of the landmark and/or identifier derived from the landmark.

12. User equipment according to claim 1, wherein the UE is configured to determine a quality value for the relative position; wherein the quality depends on the between the UE environmental conditions and the landmark, landmark condition and/or sensor quality used to determine the relative position.

13. User equipment according to claim 1, wherein the UE is configured to determine a parameter quality on the accuracy of the identified and/or estimated parameters.

14. User equipment according to claim 1, wherein the UE is configured to determine a quality value on the detectability and/or certainty of the landmark.

15. User equipment according to claim 1, wherein the configuration comprise conditions for utilizing the landmarks; and
wherein the conditions comprise at least one of applicable functionality, applicable RRC configuration and/or model pairing ID; and/or wherein the conditions comprise information on generating ground truth label when a landmark is identified.

16. User equipment according to claim 1, further comprising a sensor (e.g. camera, sonic sensor, RFID sensor, NFC etc.) configured to identify the landmark and/or the one or more parameters; and/or
wherein the transceiver is used as a sensor for determining the one or more parameters.

17. User equipment according to claim 1, further comprising an additional sensor, like RADAR, Vision (e.g. Camera), Audio, IMU, GNSS, position, or LIDAR to determine the one or more parameters.

18. User equipment according to claim 1, wherein user equipment is configured to associate the one or more parameters with the one or more landmarks, e.g. based on a time correlation (offset dependent on UE speed.

19. User equipment according to claim 1, wherein the UE is configured (or pre-configured) to measure or to determine a report measurements or sensor information related to the landmark to the network or wherein the UE is authorized by the network to report measurements related to the positioning reference signals to the entity controlling the sensor related to the landmark detection and related measurements; and/or
wherein the measurements on the positioning reference signal is performed at a position assignable to the measurements related to the one or more landmark;

20. User equipment according to claim 1, wherein the UE is configured to determine a deviation with respect to space and/or time of the to the one or more identified landmarks from an expectation as parameter (and/or matching indicator).

21. User equipment according to claim 1, wherein the transceiver is configured to operate with 5G signaling in a mobile network (in combination with sensors the UE); and/or
wherein the transceiver is configured to operate with 5G signaling supporting the LCM and/or used for identifying of the landmarks.

22. User equipment according to claim 1, wherein the configuration refers to one or more landmarks in the current surrounding of the UE.

23. User equipment according to claim 1, wherein the user equipment is configured to perform in response to receiving one of the following steps:
notifying a network entity with configuration;
receiving capability requests;
providing capability information, e.g., about sensor capability, positioning
informing the NW on the one or more applied sensors
receiving report configuration;
receiving condition on operation and/or data collection;
performing measurement for, reporting on or transmitting the one or more parameters.

24. User equipment according to claim 1, wherein one network entity is configured to perform life cycle management of the ML model, wherein life cycle management comprises one of the following monitoring, updating, verifying, training, testing and/or maintaining the ML model.

25. User equipment according to claim 1, wherein the inference model is deployed at the network entity, wherein the UE is configured to provide parameters derived or associated with the landmark for the ML monitoring, or data collection, or ML model training.

26. User equipment according to claim 1, wherein the user equipment is configured to perform in response to the receiving one of the following:
receiving AD to determine the expected UE model inference output;
reporting on data validity;
notifying monitoring event;
reporting on monitoring metrics of the ML model;
training, verifying, updating, maintaining, testing and/or validating the ML model;
providing a report comprising landmark ID and/or position of the user equipment.

27. User equipment according to claim 1, wherein the user equipment comprises a processor configured to train and/or monitor and/or validate and/or test and/or update and/or maintain the ML model based on the identified one or more landmarks and/or the one or more parameters; and/or
wherein the user equipment comprises a processor configured to perform life cycle management of the ML model, wherein life cycle management comprises one of the following monitoring, updating, verifying, training, testing and/or maintaining the ML model.

28. User equipment according to claim 1, wherein the user equipment is configured to perform in response to identifying one of the following:
triggering an action or a lower layer action or high layer action based on the trigger;
triggering to transmit and/or the measurements on a position reference signal, if the one or more landmark is detected and/or requesting the related measurement results;
performing measurement using one or more sensors and/or the transceiver of the user equipment;
reporting a one or more parameters associated with the one or more identified landmark;
performing validation based on the one or more parameters and a ground truth label;
performing training based on the one or more parameters and a ground truth label;
transmitting a reference signal or receiving a reference signal;
reporting on measurements performed during identifying; and/or
generating a user equipment position; and/or
performing life cycle management of the ML model comprising one of monitoring, updating, verifying, testing, maintaining.

29. User equipment according to claim 1, wherein the user equipment is configured for collecting training data and/or monitoring and/or validating and/or preforming model calibration of one of the following:
LCM phases (training, testing/validation, inference, monitoring and model/functionality management);
Landmarks for training;
Landmarks for testing/validation;
Landmarks for inference;
Landmarks for model/functionality performance monitoring;
Landmarks for model/functionality management.

30. User equipment according to claim 1, wherein the one or more landmarks are out of the group comprising one of the following:
visual landmarks;
landmarks determined using camera or a lidar;
QR code as landmark;
acoustic landmark;
RF landmark;
RFID landmark;
landmark determined using a transceiver.

31. User equipment according to claim 1, wherein the transceiver is configured to provide the Network entity information about the additional sensor capabilities.

32. User equipment according to claim 1, wherein the transceiver is configured to provide information on the sensor like quality, class or category or device information enabling network entity to derive the sensor quality, class or category information.

33. User equipment according to claim 1, wherein the transceiver is configured to provide receive configuration the according to the UE sensor capabilities, wherein the configuration comprises one or more landmarks are out of the group supported by the UE.

34. User equipment according to claim 1, wherein the landmarks are out of the group comprising unique landmarks, general landmarks and/or temporal landmarks.

35. User equipment according to claim 1, wherein the one or more landmarks comprise a ground truth label, like a location dependent information and/or orientation dependent information; and/or
wherein the UE is configured to extract ground truth label from the one or more landmarks; and/or
UE is configured to provide ground truth label in response to a trigger (e.g. trigger from higher layers); and/or
wherein the UE uses the one or more landmarks as a ground truth label or as reference points.

36. User equipment according to claim 1, wherein the one or more parameters comprise a ground truth information, such as the orientation of the UE with respect to the QR code, rough distance to the QR code, NFC measurement, RF measurement, GNSS measurement, RF signal exchanged with TRP, sidelink communication exchanged with TRP, downlink positioning reference signal, side link positioning reference signal, channel state information reference signal; and/or demodulation reference signal.

37. User equipment according to claim 1, wherein UE is configured to generate one or more additional labels (relative to this reference point) or training data; and/or
wherein UE is configured to generate ground truth labels or training data (e.g. in response to network request); and/or
wherein UE is configured to generate one or more additional labels or training data relative to the one or more landmarks.

38. User equipment according to claim 1, wherein user equipment is a reference user equipment being identified and/or designated by the network to comprise specific capabilities, such as assisted label generation for positioning or communication usages; and/or
wherein user equipment is configured to generate one or more landmarks or landmark information for the one or more landmarks being associated with specific operations and/or to provide landmark information for the one or more landmarks and/or to report the landmark information for the one or more landmarks along with a timestamp; and/or
wherein user equipment is configured to generate landmark information associated with a measurement or transmission.

39. User equipment according to claim 1, wherein UE is a non-reference user equipment reference user equipment and/or capable of providing reference information that can contribute to the process or LCM, like monitoring, training, validation, calibration.

40. User equipment according to claim 1, wherein the user equipment is configured to trigger or configured to (uplink or sidelink) transmit specific signal(s, resource(s), or resource set(s) to enable measurements to be made by the network entity or another device.

41. User equipment according to claim 1, wherein the user equipment is configured to
receive information from the network entity regarding a one or more landmarks (associated with at least one downlink or uplink resource or measurement;
utilize the received information in beam management process to optimize beam configuration and selection;
enhance the beam management and communication performance based on the association between the landmark and the received information.

42. User equipment according to claim 41, wherein a landmark beam information is associated with a narrow set of beam selection from a wider set; and/or by use of a beam configuration based on the landmark information a preferred beam is suggested or selected; and/or wherein UE adjusts its beam selection to avoid the non-preferred beams indicated by the network (or not associated with a landmark); and/or wherein the user equipment is configured to track a movement between landmarks using the associated beams.

43. User equipment according to claim 1, wherein the (static) user equipment is deployed by the network entity for monitoring purposes or as a positioning reference unit or for performing measurements (such as RSTD, RSRP, UE Rx-Tx Time Difference, DL-RSCPD, DL-RSCP) and to report the measurement to the network entity; and/or to transmit uplink reference signals (enabling the network nodes to measure and/or calibrate the uplink measurements).

44. Network entity comprising a transceiver for exchanging data supporting life cycle management of a machine learning model and being configured to initiate identification of one or more landmarks of the machine learning model, such that a UE can acquire one or more parameters on the one or more landmarks;
wherein exchanging data comprises transmitting data supporting life cycle management (LCM) and used by an user equipment to identify the one or more landmarks and/or to acquire one or more parameters on the one or more landmarks.

45. Network entity according to claim 44, wherein exchanging data comprises transmitting a configuration to a UE, the configuration indicating information on the one or more landmarks or a criteria to identify the one or more landmarks and receiving one or more parameters or and information derived from the one or more parameters from the user equipment.

46. Network entity according to claim 44, wherein exchanging data comprises receiving landmark information and wherein the network entity is configured to perform a measurement or to utilize the landmark information and measurements from another device to establish the training data; and/or
wherein the network entity is configured to receive landmark information and measurements, and to generate a label associated with the specific operation based on the landmark information and measurements.

47. Network entity according to claim 44, wherein the network entity is configured to transmit a RequestAssistanceData message or RequestAssistanceData message including or excluding type of landmark assistance and/or RequestLocationInformation message; and/or
wherein the network entity is configured to transmit a list of landmarks and/or additional assistance and/or information associated with a validity time and/or validity area (e.g. =a portion of the cell indicated using a GAD shape, or cells, portion of cell, combination of cells).

48. System comprising a user equipment according to claim 1 and network entity according to claim 44.

49. System according to claim 48, comprising another device configured to generate measurements (for the specific operation); and/or
wherein the user equipment or the network entity is configured for associating the landmark information and measurements (with the specific operation) to generate a label for the operation

50. Method for supporting life cycle management (LCM) of machine learning model (ML model), comprising the following steps:
exchanging data supporting life cycle management (LCM) of machine learning model (ML model) and
identifying one or more landmarks to acquire one or more parameters on the one or more landmarks;
wherein identifying comprises determining the one or more parameters on the one or more landmarks based on the data supporting life cycle management (LCM), the one or more parameters describe at least a presence of the one or more landmarks;
wherein the one or more parameters or an information derived from the one or more parameters is transmitted by the transceiver as part of exchanging data or wherein based on the one or more parameters an information is derived and/or a trigger is acquired or an utilizing the one or more landmarks is performed.

51. Method according to claim 50, wherein exchanging data comprises receiving a configuration (or pre-configuration) from one or more network entities (NW, RAN, OTT, server), the configuration indicating information on the one or more landmarks or criteria to identify the one or more landmarks;
wherein identifying the one or more landmarks is based on information comprised by the configuration;

52. Method for supporting life cycle management (LCM) of machine learning model (ML model), comprising the following steps:
supporting life cycle management (LCM) of machine learning model (ML model) and identifying one or more landmarks to acquire one or more parameters on the one or more landmarks;
wherein identifying comprises determining the one or more parameters on the one or more landmarks based on the data supporting life cycle management (LCM), the one or more parameters describe at least a presence of the one or more landmarks;
wherein based on the one or more parameters an information is derived and/or a trigger is acquired or wherein the one or more parameters or an utilizing the one or more landmarks is performed or an information derived from the one or more parameters is transmitted by the transceiver.

53. Method according to claim 52, wherein the user equipment (UE) comprises a configuration (or pre-configuration), the configuration indicating information on the one or more landmarks or criteria to identify the one or more landmarks;
wherein identifying the one or more landmarks is based on information comprised by the configuration.

54. Method for performing life cycle management, comprising the following steps:
exchanging data supporting the life cycle management of a machine learning model and
initiating identification of one or more landmarks of the machine learning model based on the data supporting life cycle management (LCM), such that a UE can acquire one or more parameters on the one or more landmarks.

55. Method according to claim 54, wherein exchanging data comprises transmitting a configuration to a UE, the configuration indicating information on the one or more landmarks or a criteria to identify the one or more landmarks and receiving one or more parameters or and information derived from the one or more parameters from the user equipment.

56. A non-transitory digital storage medium having a computer program stored thereon to perform the method according to claim 50 or 52 or 54 when said computer program is run by a computer.
